(19) United States
(12) Patent Application Publication
(10) Pub. No.: US 2024/0197106 A1
(43) Pub. Date: Jun. 20, 2024

(54) Appliance for Grinding of Foodstuffs

(71) Applicant: JDP IP LLC, Weston, MA (US)

(72) Inventors: Zachary CARLINS, Chicago, IL (US); James Shepard, Marblehead, MA (US); Joshua I. Ferris, Boston, MA (US); Aaron Panone, Medford, MA (US); Samantha Borri, Boston, MA (US); Niku Angier, Wakefield, RI (US); Yen Wei Lee, Newton, MA (US); James D. Philipkosky, Weston, MA (US)

(73) Assignee: JDP IP LLC, Weston, MA (US)

(21) Appl. No.: 18/542,111

(22) Filed: Dec. 15, 2023

Related U.S. Application Data
(60) Provisional application No. 63/546,231, filed on Oct. 29, 2023.
(60) Provisional application No. 63/532,662, filed on Aug. 14, 2023.
(60) Provisional application No. 63/433,327, filed on Dec. 16, 2022.

(51) Int. Cl. A47J 31/42; A47J 31/44

(52) U.S. Cl. CPC A47J 31/42; A47J 31/4403

(57) ABSTRACT

A consumer countertop grind-and-brew machine for coffee, or a grinder for nut butter and similar foodstuffs. The grinder burr and container for pre-ground food are connected, so that they can be replaced as an assembly. Thus, different family members that like caffeinated and decaffeinated coffee, or that prefer peanut, almond, and cashew butter can each grind their own preferred foodstuff, and swap out the grinder between to prevent cross-contamination.

This application claims benefit of U.S. Provisional application Ser. No. 63/546,231, filed Oct. 29, 2023, titled Appliance for Grinding of Foodstuffs; U.S. Provisional application Ser. No. 63/532,662, filed Aug. 14, 2023, titled Appliance for Grinding of Foodstuffs; and U.S. Provisional application Ser. No. 63/433,327, filed Dec. 16, 2022, titled Appliance for Grinding of Foodstuffs. The priority applications are incorporated by reference.

### BACKGROUND

This application relates to apparatus for grinding foodstuffs.

### SUMMARY

In general, in a first aspect, the invention features a method, and apparatus for performance of the method. A first cup of coffee is brewed in a consumer coffee brewer machine. The machine is a consumer countertop appliance with a motor designed to drive a grinder burr, and an area to receive ground foodstuff. A first grinder/container assembly has a grinder burr and a container designed to hold whole coffee beans to be ground. A coupling between the countertop appliance and grinder/container assembly coupling is designed to transmit power from the motor to the grinder burr. The coupling is designed to permit separation of the grinder/container assembly from the countertop appliance and replacement in the countertop appliance of another grinder/container assembly. Replacement may be without use of tools. After the first cup of coffee is brewed, the first grinder/container assembly is removed from the countertop appliance, perhaps without the use of tools. A second grinder/container assembly is coupled into the countertop appliance, without the use of tools.

In general, in a second aspect, the invention features an apparatus, and methods of using that apparatus. The apparatus has a grinder burr, a grinder housing, and a grinder-to-appliance coupling. The grinder housing is designed to mount the grinder burr in a countertop appliance. The grinder housing is designed to receive drive power from a motor of the countertop appliance for drive of the grinder burr. The grinder housing is designed to retain a container for unground foodstuffs as a container/grinder assembly. The grinder housing is designed to retain the container positioned for gravity feed into the grinder burr. The grinder housing is designed to facilitate handling of the container and grinder burr as an assembly. The grinder housing is designed to retain the grinder burr in a fashion and location to direct foodstuffs to flow from the container into the grinder burr, and to direct ground foodstuffs to be delivered into a receptacle. The grinder-to-appliance coupling is designed to permit a user to readily mount the container/grinder assembly in and remove from the countertop appliance assembly, and replacement in the appliance with another container/grinder assembly.

In general, in a third aspect, the invention features an apparatus, and methods of using that apparatus. The apparatus includes a container for unground foodstuffs. The container has a connector for connection to a grinder housing. The grinder housing is designed to mount a grinder burr in a countertop appliance. The grinder housing is designed to receive drive power from a motor of the countertop appliance for drive of the grinder burr. The grinder housing is designed to retain the container for unground foodstuffs as a container/grinder assembly, with the container positioned for gravity feed into the grinder burr, and for handling of the container and grinder burr as an assembly. The grinder housing is designed to retain the grinder burr in a fashion and location designed to direct foodstuffs to flow from the container into the grinder burr, and to direct ground foodstuffs to be delivered into a receptacle. A grinder-to-appliance coupling of the grinder housing is designed to permit a user to readily mount the container/grinder assembly in and remove from the countertop appliance assembly, and replacement in the appliance with another container/grinder assembly.

In general, in a fourth aspect, the invention features an apparatus, and methods of using that apparatus. An apparatus has a grinder burr and a filter basket. The grinder burr is arranged for rotation on a vertical axis, and to distribute grounds from its bottom in a conical distribution to land in an annulus. The filter basket below the grinder burr is designed to collect grounds from the grinder burr and to direct water to percolate through the grounds, a water heating and distribution system, and a computer control. The filter basket is formed of materials suitable for use with foodstuffs and exposure to hot water, the filter basket has features to engage with mating features of a grind-and-brew machine for hot beverages, the filter basket has a raised center and a surrounding annular volume arranged at a diameter to collect the grounds as they fall from the grinder burr, and has screens of porosity to direct hot beverage to flow through the screens while preventing throughflow of grounds, the raised center and screens designed to encourage water flow through the grounds for a desired level of extraction.

In general, in a fifth aspect, the invention features an apparatus, and methods of using that apparatus. An apparatus has a container, a grinder housing, a grinder-to-container coupling, and a grinder-to-appliance coupling. The container for unground foodstuffs has a connector for connection to a grinder housing. The container is designed to hold a quantity of foodstuff up to about 3 liters. The grinder housing is designed to mount a grinder burr in a countertop appliance. The grinder housing is designed to receive drive power from a motor of the countertop appliance for drive of the grinder burr. The grinder housing is designed to retain the container for unground foodstuffs as a container/grinder assembly, with the container positioned for gravity feed into the grinder burr, and for handling of the container and grinder burr as an assembly. The grinder housing is designed to retain the grinder burr in a fashion and location to direct foodstuffs to flow from the container into the grinder burr. The grinder-to-appliance coupling of the grinder housing is designed to permit a user to readily mount the container/grinder assembly in and remove from the countertop appliance assembly. The container and/or container-to-grinder coupling is designed to deter refilling of the container.

In general, in a sixth aspect, the invention features an apparatus, and methods of using that apparatus. An apparatus has a filter basket. A filter basket is formed of materials suitable for use with foodstuffs and exposure to hot water. The filter basket has features to engage with mating features of a grind-and-brew machine for hot beverages. The filter basket is designed to hold ground foodstuff ground by a grinder burr and to direct flow of water in a manner designed to brew hot beverages. The bottom of the filter basket has a raised center sloping away from the center and designed to promote outward flow of water. The filter basket has screen openings at or near the outer periphery of the filter basket. A ratio of the diameter to depth of the filter basket is at least about 2.5 to 1.

In general, in a seventh aspect, the invention features an apparatus, and methods of using that apparatus. An apparatus has a grinder burr, a filter basket, and a steam shield. The grinder burr is designed to grind foodstuff. The filter basket is designed to hold ground foodstuff ground by the grinder burr and to direct flow of water in a manner designed to brew hot beverages. A steam shield is designed to lie in an open position during operation of the grinder burr to direct passage of grounds from the grinder burr to the filter basket. The steam shield is designed to lie in a closed position after grinding and during brewing to protect the grinder burr from escape of steam from the brewing process. The steam shield has on its lower surface one or more distribution openings designed to distribute water to the ground foodstuff in the filter basket for brewing.

In general, in a eighth aspect, the invention features an apparatus, and methods of using that apparatus. A brewer for hot beverages has a water pump and a controller. The water pump is designed to distribute hot water to ground coffee in a brewing chamber of the coffee brewer appliance. The controller designed to improve wetting of or extraction from the ground food stuff during brewing by pulsing the water pump during brewing.

In general, in a eighth aspect, the invention features an apparatus, and methods of using that apparatus. An apparatus has a rotary grinder burr and a filter basket. The filter basket is designed to hold ground coffee ground by the grinder burr and to direct flow of water in a manner designed to brew coffee. A brew basket surrounding the filter basket is designed to catch brewed coffee exiting the filter basket. The brew basket has a drip valve actuated by a motor of the appliance, the drip valve designed to allow flow of coffee or prevent flow of coffee as determined by a controller of the appliance.

In general, in a ninth aspect, the invention features an apparatus, and methods of using that apparatus. A consumer countertop appliance has a motor designed to drive a grinder burr, and an area to receive ground foodstuff. A controller that controls the rotation of the motor and grinder burr is programmed to drive the motor in a grinding direction to drive the grinder burr to grind foodstuff during a grind cycle. The controller is programmed to conclude the grind cycle with a short time to drive the grinder burr in a reverse direction to clear the grinder burr and other rotating components of residual ground foodstuff.

Embodiments of the invention may include one or more of the following features. These features may be used singly, or in combination with each other. The grinder-to-appliance coupling and a grinder-to-container coupling may be jointly designed to permit ready separation and replacement of the grinder/container assembly from and into the appliance while holding the container in the container/grinder assembly without separating. The grinder-to-appliance coupling may be designed to permit a user to readily mount the container/grinder assembly in and remove from the countertop appliance assembly without the use of tools. The grinder-to-container coupling may be designed to allow the user to separate the container from the grinder housing without the use of tools. The grinder-to-container coupling may be designed to impair reuse of the container after separation. The path from grinder to ground foodstuff receiving area may be designed for nearly vertical drop. The path from grinder to receiving area may be designed for reduced sticking of ground foodstuff. The container and grinder burr may be designed for unground whole bean coffee. The container and grinder burr may be designed to grind unground beans to grounds for brewing. The appliance may have a water delivery system and water heater for delivery of water for brewing of coffee. A rotational axis of a drive motor may be different that the vertical axis of rotation of the grinder burr. Gears and/or belts may be designed to transfer rotational impulse from the motor to the rotary grinder burr. Support ribs may be designed to positionally retain the grinder burr relative to the filter basket. The support ribs may be angled to reduce sticking of falling grounds. Vertical stationary walls of a fall path from the grinder burr may be designed to shield rotating walls from the grounds to reduce sticking. The container and/or container-to-grinder coupling may be designed to permit decoupling of the grinder burr from the container and to deter refilling of the container, and re-coupling of a new container, without use of tools. The container-to-grinder coupling and/or container may have features that, during disconnection of the grinder from the container, may be designed to deform features of the container and/or the container side of the container-to-grinder coupling so that the container-to-grinder coupling cannot be reused. The container-to-grinder coupling may have features that actuate a safety switch of the appliance when the grinder and container may be connected. The deformation of the container and/or the container side may be designed to prevent actuation of the safety switch after the deformation. Components of the container-to-grinder coupling may be designed to snap to hold features of the container-to-grinder coupling in an inoperative position designed to prevent reuse of the container-to-grinder coupling. The container-to-grinder coupling may be designed with an inclined ramp and features that ride that ramp during rotation of components of the coupling. The container-to-grinder coupling may have features that, during disconnection of the grinder from the container, may be designed to yield so that the first coupling cannot be reused. The container-to-grinder coupling may have features that require the user to deform the features in order to release the container from the grinder. The bottom of the filter basket may be water impermeable. Screen openings may be in vertical sides for the filter basket. The bottom of the filter basket may be shaped as a surface of rotation around a central axis of the filter basket of a curve has a higher pitch toward the center and a flattening toward the periphery. The ratio of the diameter to depth of the filter basket may be at least about three to one. The steam shield and water distribution leading to the distribution openings may be formed as an integral part designed to move together on a common mechanism. The steam shield and water distribution leading to the distribution openings may be formed as separately molded parts joined together into an integral part. The water control may be programmed to deliver relatively short pulsing to cause spray to hit different points of the grounds. The water control may be programmed to deliver relatively longer pulsing to effect flood-and-drain brewing. The water control may be programmed to deliver pulsing between on and off, or between low and high flow rate. The water control may be programmed to deliver water and a pulsing pattern tailored to the volume of the brew. The valve may be a stopper valve or a bit valve. The brew basket and filter basket may be designed to permit the user to remove them from the appliance for cleaning. The drip valve may be configured in a normally closed position, such that the valve remains closed when the brew basket is removed from the appliance.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### DESCRIPTION OF THE DRAWINGS

FIGS. 1A to 1J, 2A, 3C, 5A, 5F, 6A-6J, 7A, 9A, 9C, 9D, 10B, 10E, 12B, 12E, 13E, 13G, 13H, 13I, and 14A-14D are perspective drawings.

FIGS. 2B to 2D, 5H, 6K, 8A, 8C, 8D, 8F, 10A, 10G, 10I, 10K, 12A, 12C, 13F, 14E, and 14F are plan drawings.

FIGS. 2E, 2F, 3A, 3B, 3D, 4A, 4B, 4D-4O, 5C, 5D, 5G, 7B, 7C,8B, 8E, 9B, 10C, 10D, 10F, 10H, 10J, 10L, 11A-11E, 11G, 11H, 11J, 11K, 12F-12I, 13J, 14G, and 14H are plan section drawings.

FIGS. 4C, 5B, 5E, 7D, 11F, 11I, 12D, 13A-13D, and 14I are perspective drawings partially cut away.

### DESCRIPTION

The Description is organized as follows.
I. Overview
II. Affixation between removable/replaceable grinder and bean container and the remainder of the grind-and-brew apparatus
   II.A. Non-concentric grinder drive motor
   II.B. Alternative arrangements
III. Water, grinder drive train, and steam shield
   III.A. Grinder and distribution of grounds
   III.B. Heating of water
   III.C. Steam shield and showerhead
   III.D. Filter basket assembly
   III.E. Drip valve
IV. Bean container
   IV.A. Reusable bean container
   IV.B. Single-use bean container using mechanical keyed features
   IV.C. Single use container using tearing
   IV.D. Single-use bean container using short-range radio communication
   IV.E. Alternative approaches for single-use bean containers
   IV.F. Single serving reusable container
V. Other embodiments

### I. Overview

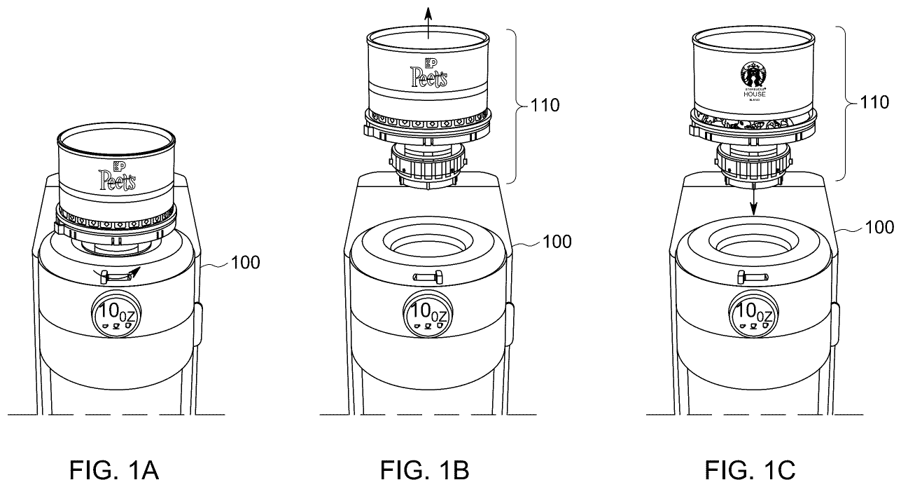

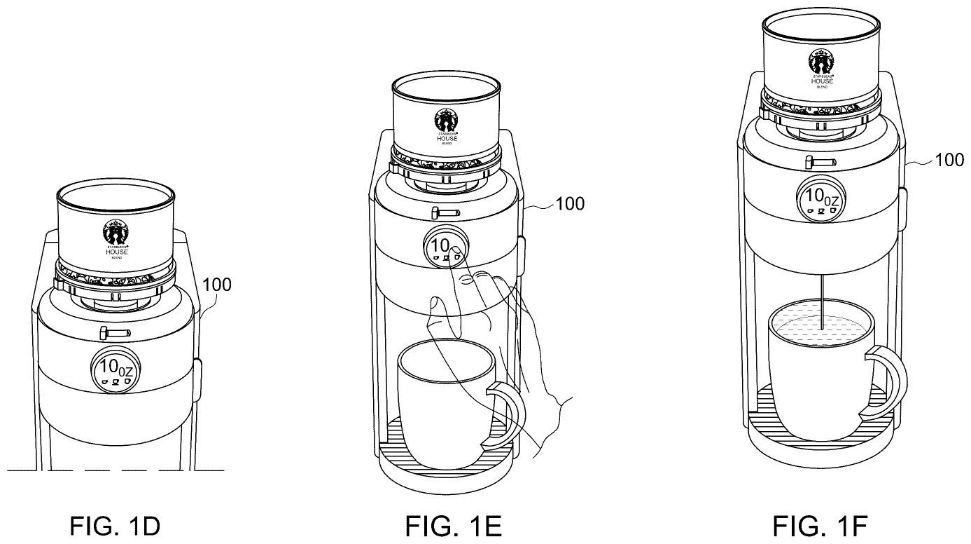

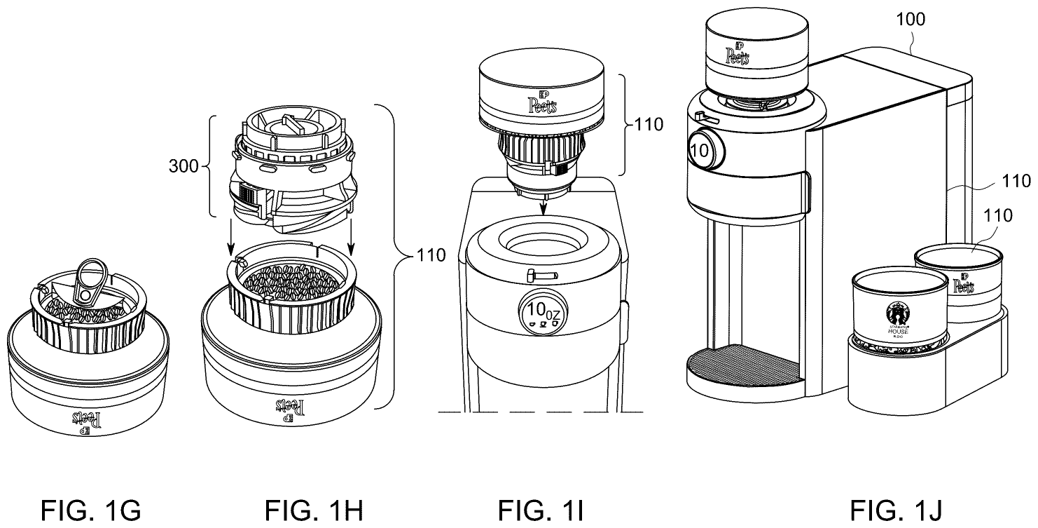

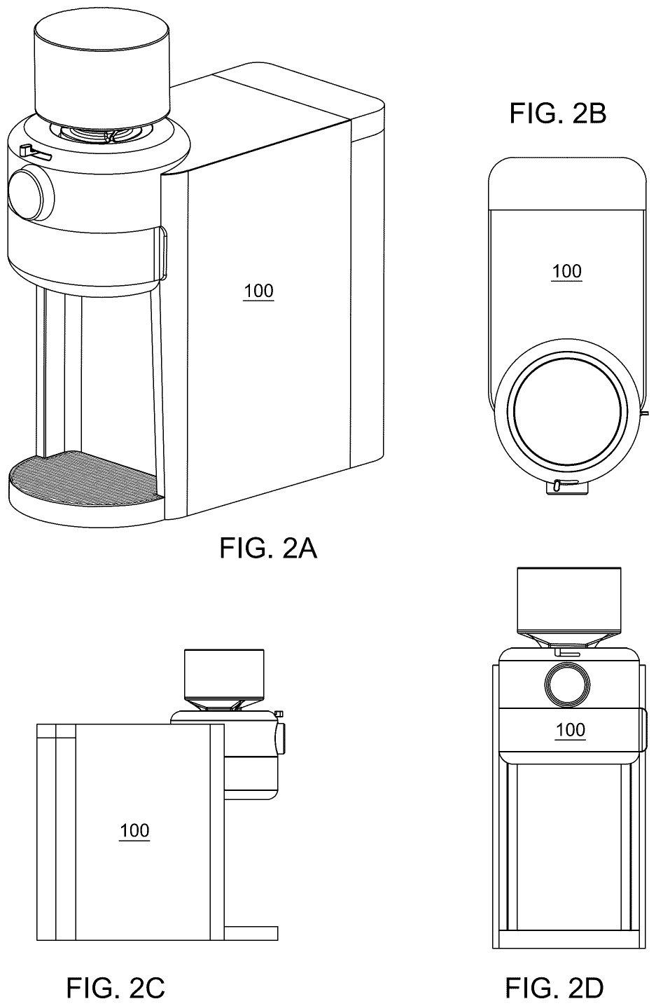

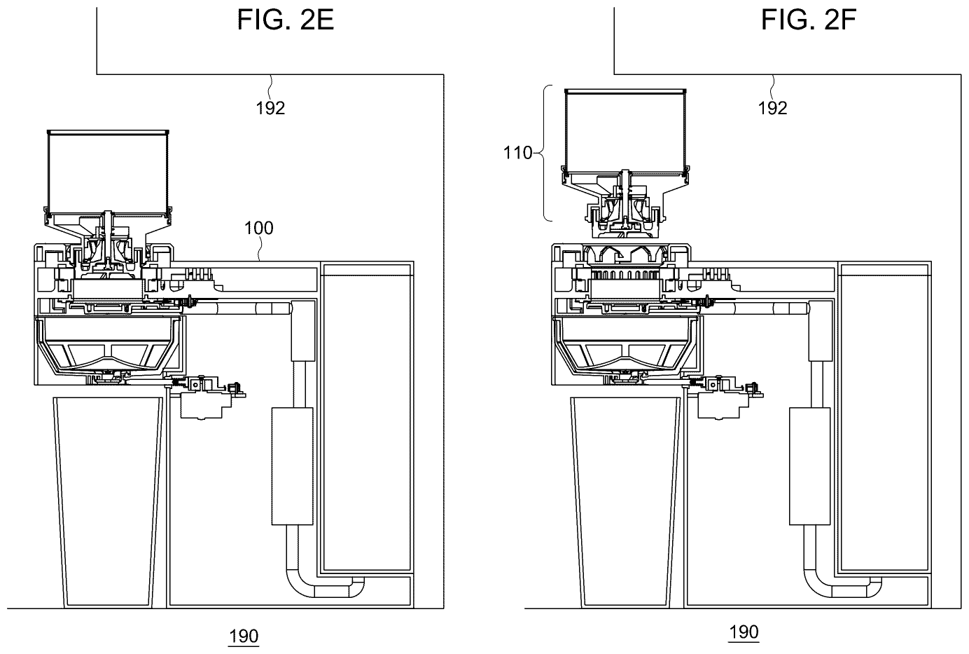

Referring to FIGS. 1A to 1J and 2A to 2F, a grind-and-brew appliance 100 for coffee and/or beverage/food development may have a grinder and bean container that replace as an integrated assembly 110, so that each cup of coffee or serving of food may use the particular beans (for example, light roast, dark roast, decaf, etc.) and grind size that is desired for individualized servings. The container may be configured to hold multiple servings of coffee beans. As a result, container/grinder assembly 110 can be left in the appliance 100 if the same coffee bean type is desired for back-to-back brews or can be removed and later reconnected when that bean type is desired again. Residue from the previous grind cycle may be minimized by either of two factors: swapping out the grinders so no residue is transferred on the grinder itself, and by a simplified grind fall path. These two techniques reduce any whole beans, partially ground beans, or previously ground beans being transferred with the grinder or in the fall chute to cross-contaminate between brew cycles. This improves freshness, and reduces cross-contamination, which is especially important in a switch from caffeinated to decaffeinated beans. Appliance 100 may provide grind-and-brew unpressurized drip capability so that the ground coffee is ground fresh from whole beans. In other cases, appliance 100 may provide either a low-pressure brew, or high-pressure (espresso) brew, or may have a switch to permit either. Appliance 100 may provide an amount of ground coffee that scales in proportion to the amount of water and desired size and strength of the serving, rather than fixed amounts of coffee used for variable-size cups. The strength can also be adjusted independently from the cup size, adjusting the proportion of grounds to water for any given cup size. In some cases, the size of the delivered beverage may range from six to eighteen fluid ounces, with the amount of ground coffee scaling appropriately. Grinder assembly 300 may be dishwasher safe. In order to provide single-cup grind-and-brew, appliance 100 may be designed to allow a user to provide the user's choice of cup or mug, rather than a fixed-height carafe, and to allow for insulated travel mugs, which may be as tall as 7½ inches. Referring to FIG. 2F, appliance 100 may be designed to fit and allow insertion/removal of grinder/container assemblies 110 within the standard seventeen-inch height between kitchen countertops 190 and overhanging cabinets 192.

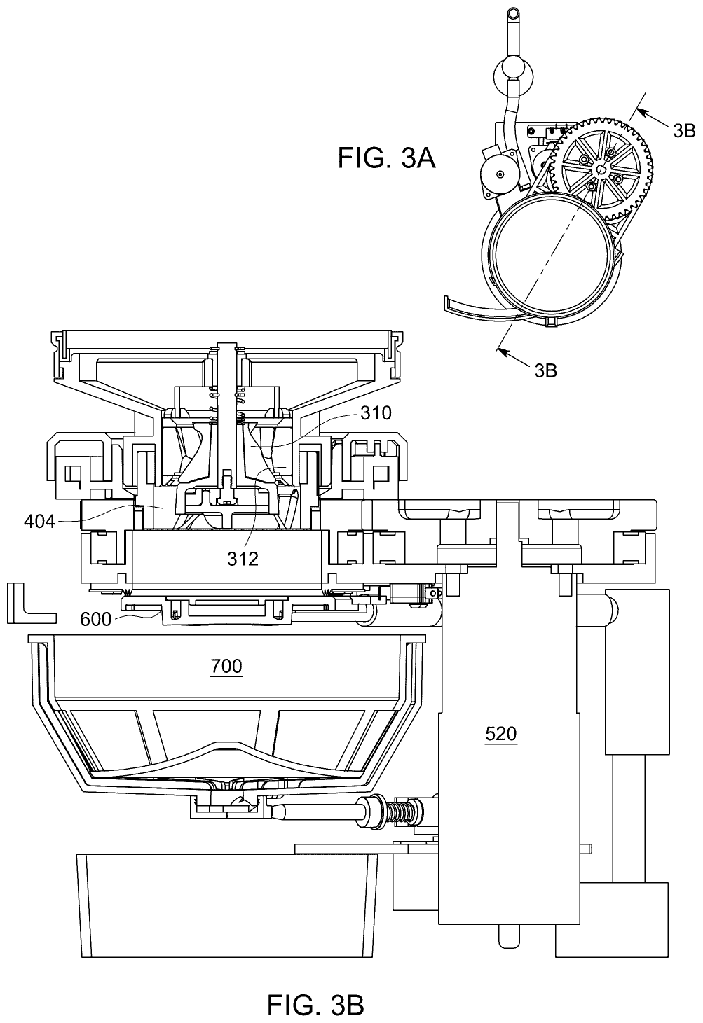

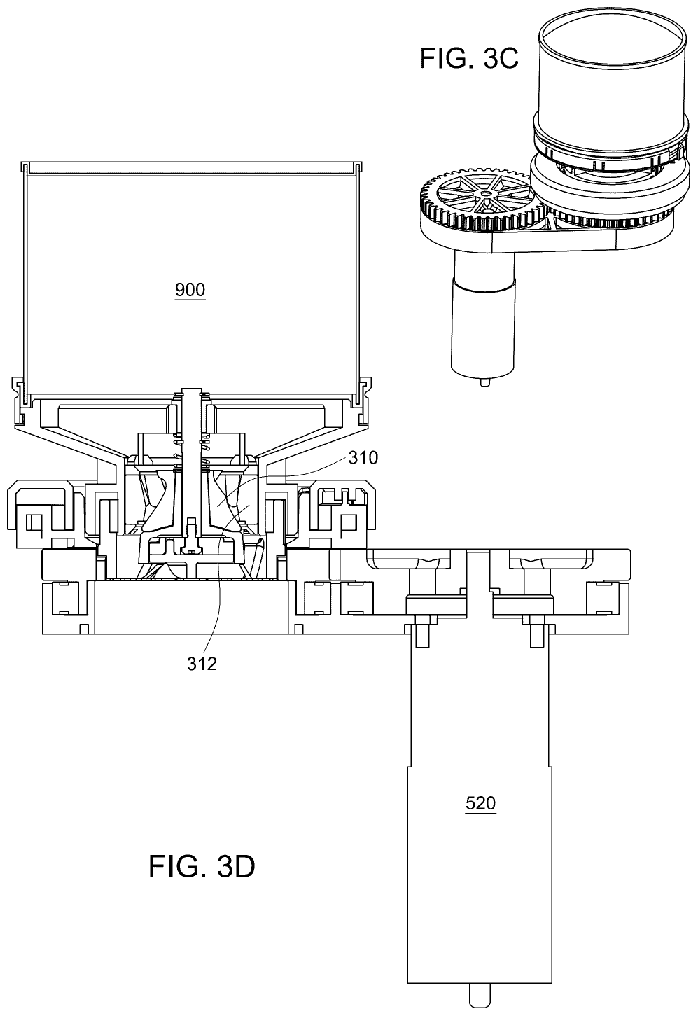

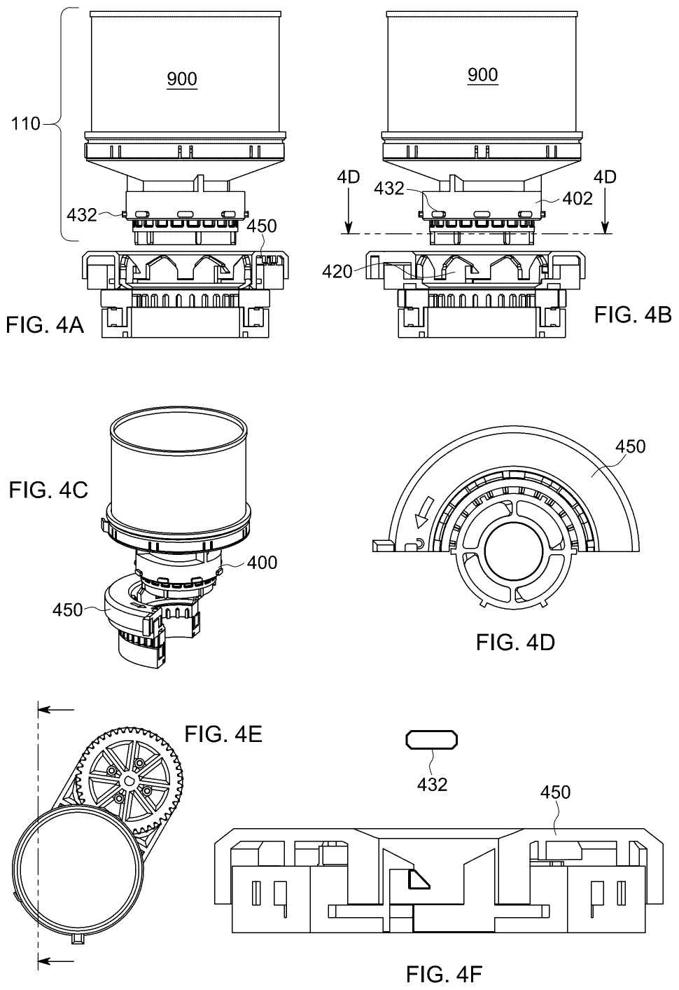

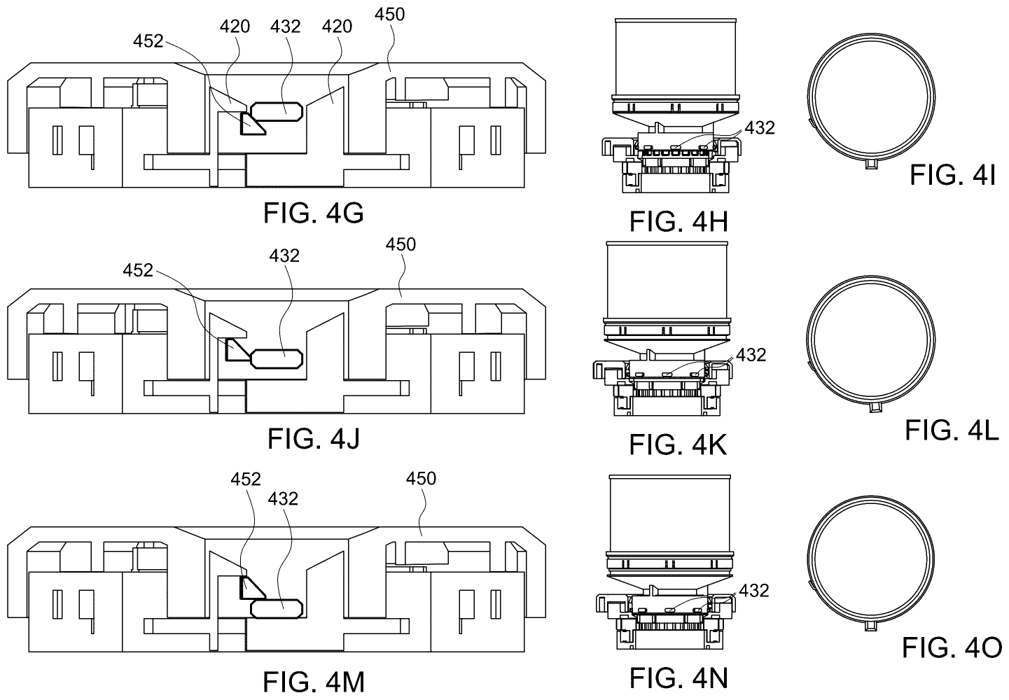

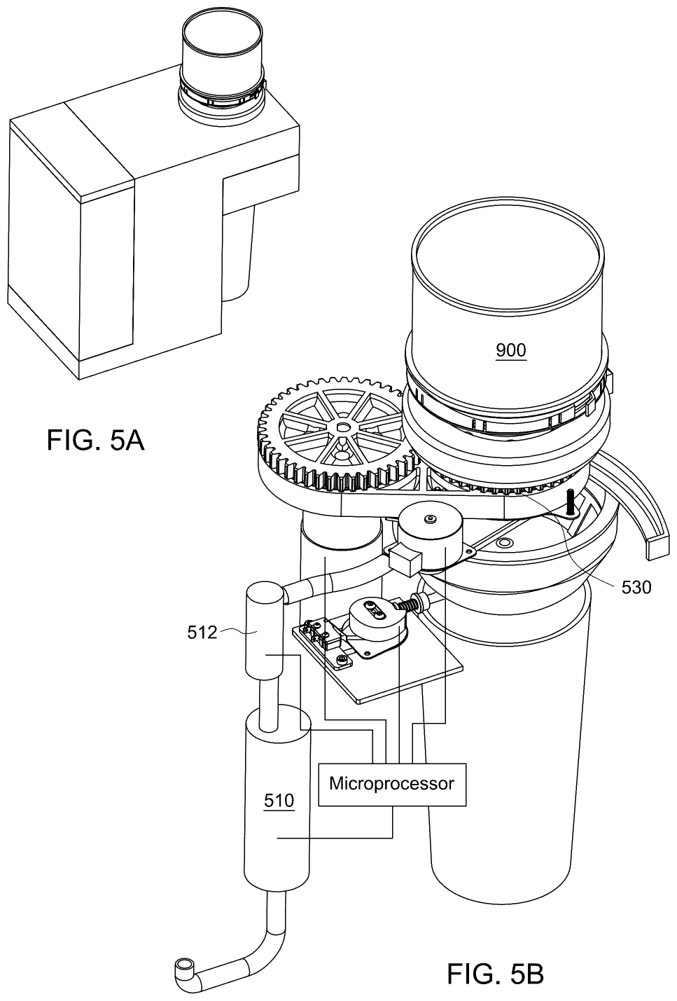

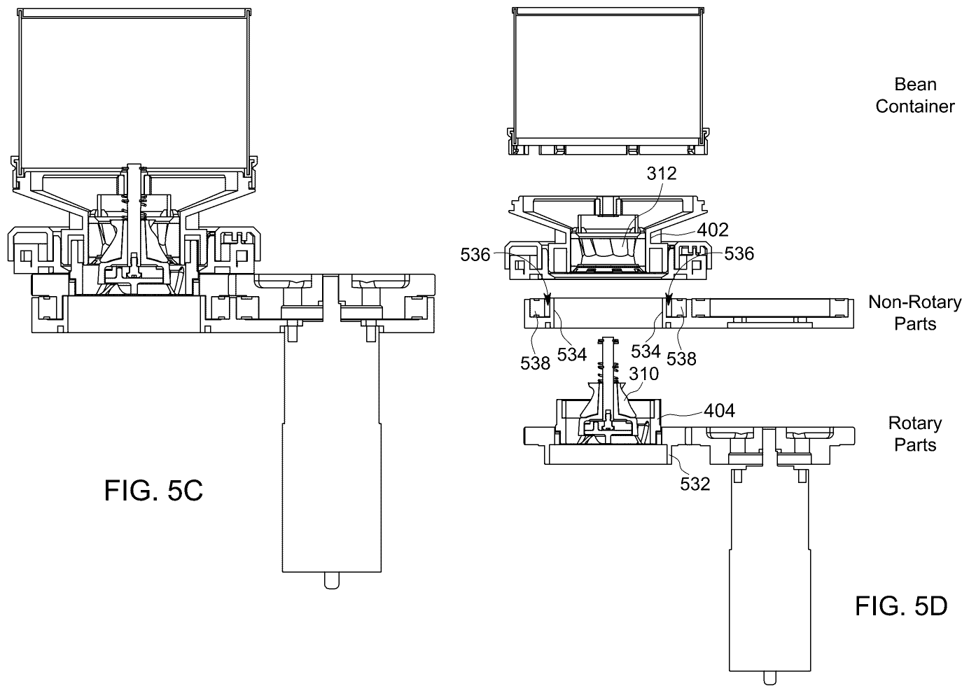

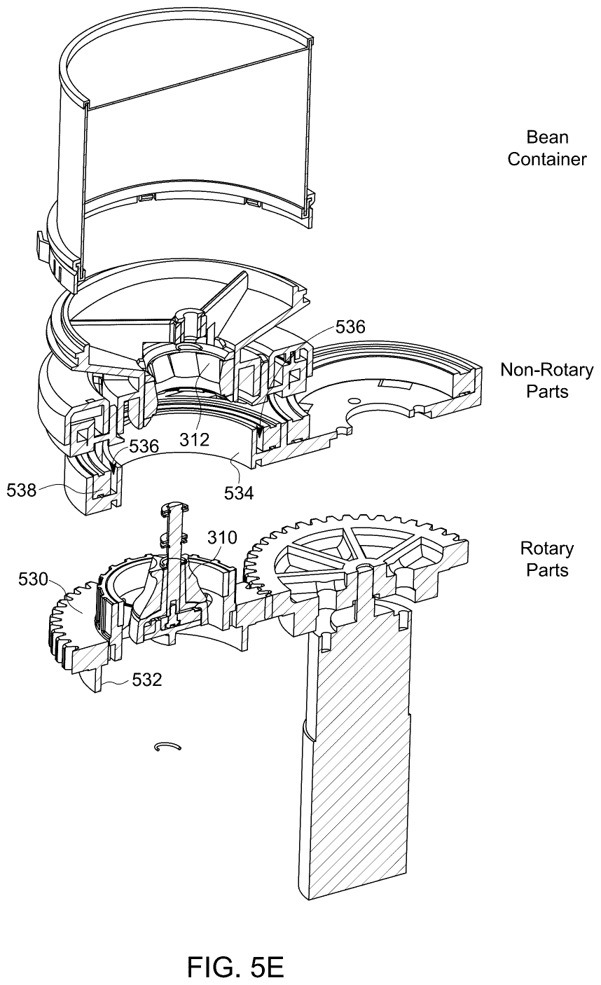

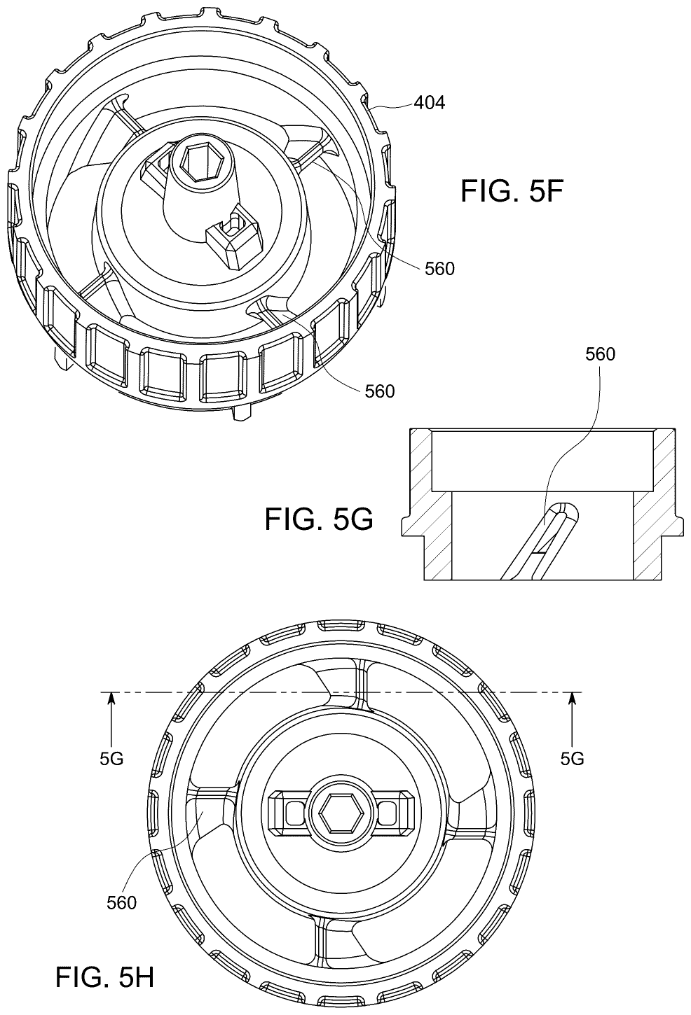

FIG. 3B is a vertical section through appliance 100, on the section line shown in FIG. 3A. Bean container 900 (see FIG. 5B) may be at the top, attached to grinder assembly 300 (see FIGS. 4A and 4B). The grinder may be a ceramic grinder burr, with generally conical inner burr 310 and a circular, cylindrical outer burr 312. In some cases, flat burrs may be used, where both grinding burrs are puck or disk shaped. In some cases, a steel or plastic burr may be used. Inner burr 310 may be mounted on inner grinder housing 404, and inner grinder housing 404 in turn may be driven by grinder drive motor 520 via a gear train. Cylindrically circular outer burr 312 may be mounted on outer grinder housing 402. The ground coffee may fall into filter basket 700, paper filter, or filter of some other material in filter basket 700. In order to allow the coffee to fall directly into filter basket 700, grinder drive motor 520 may be located off the grinder axis. After the coffee is ground, steam shield 600 with showerhead 610 may rotate into place and deliver hot water to the grounds in filter basket 700 while simultaneously shielding the grinder from rising steam. Filter basket 700 may have mesh sides or openings 720 to allow brewed coffee to flow through to outer basket 702 which collects the coffee liquid, to be delivered at an orifice, potentially with a control valve 800, to fall into a mug.

The grinder, grounds fall path, filter basket 700, and showerhead 610 for water distribution pattern may be designed together using a systems approach, with dimensions and other properties to improve the characteristics that influence quality of coffee (the amount of coffee grounds per unit of water, the temperature of the water, the contact time and flow path of the water through the grounds), while allowing replaceability of filter basket 700, grinder and bean container on a cup-by-cup basis, and fitting within the dimensions of a standard kitchen counter 190, 192.

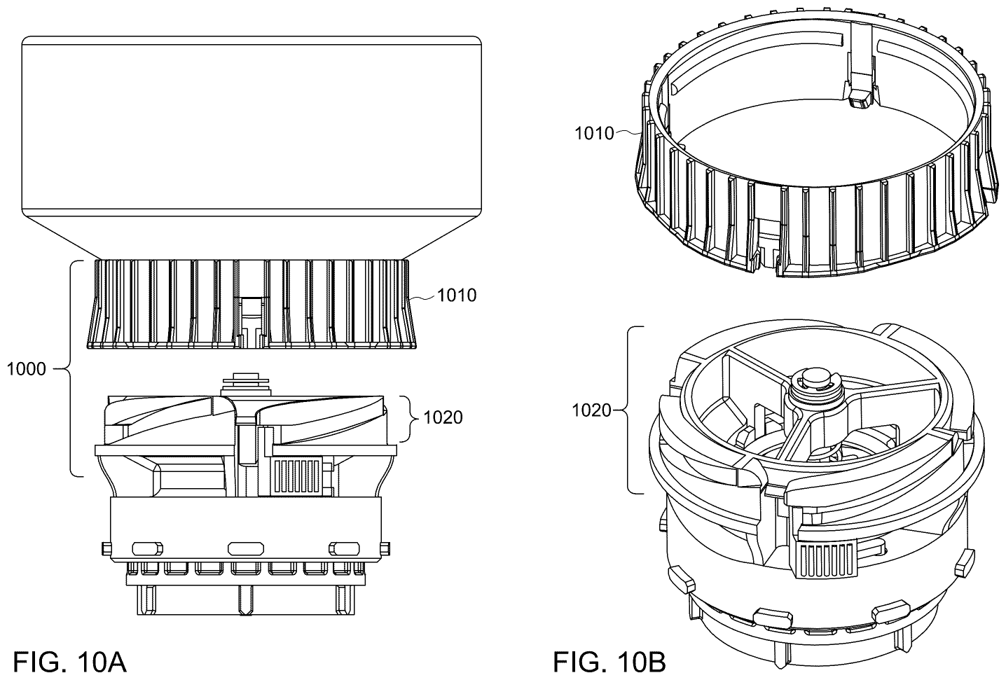

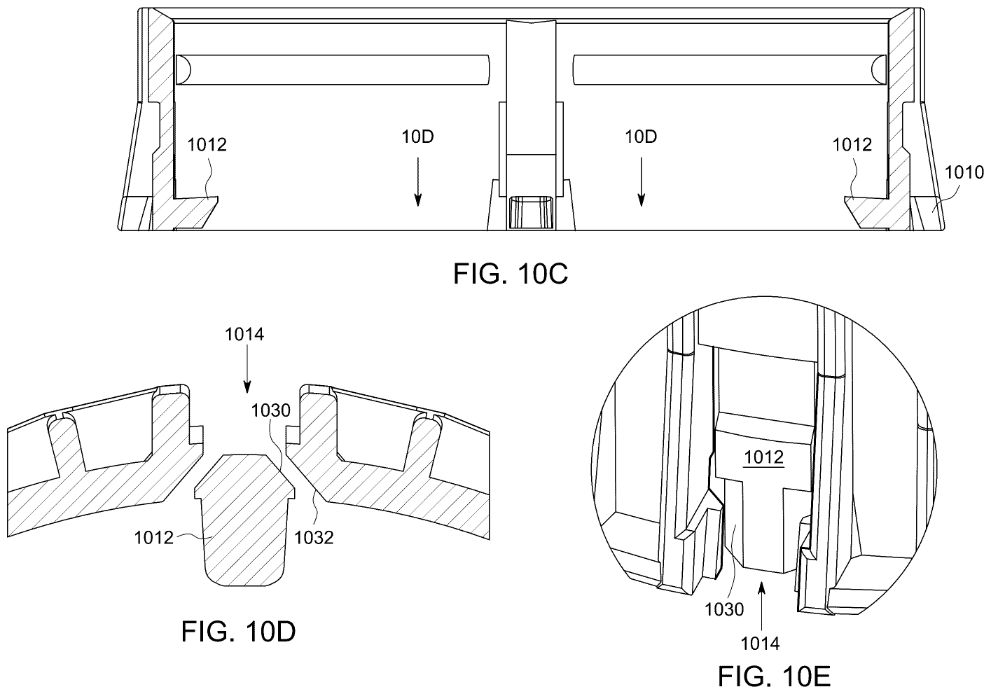

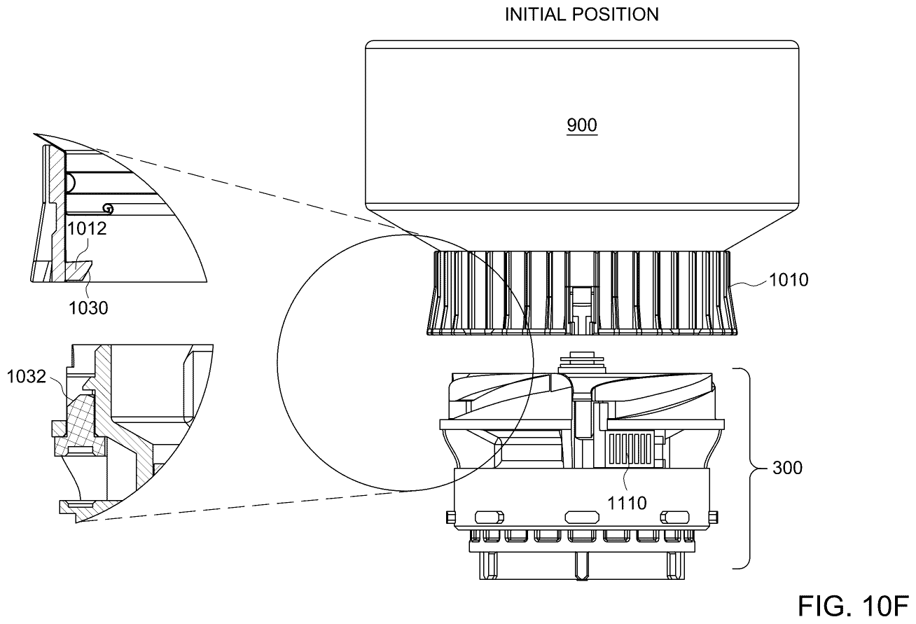

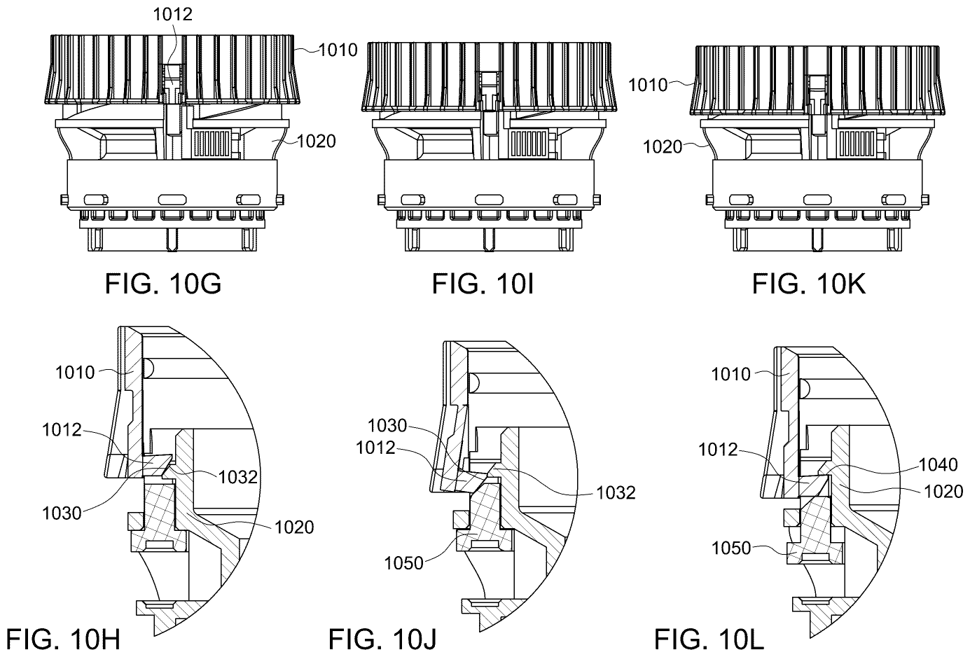

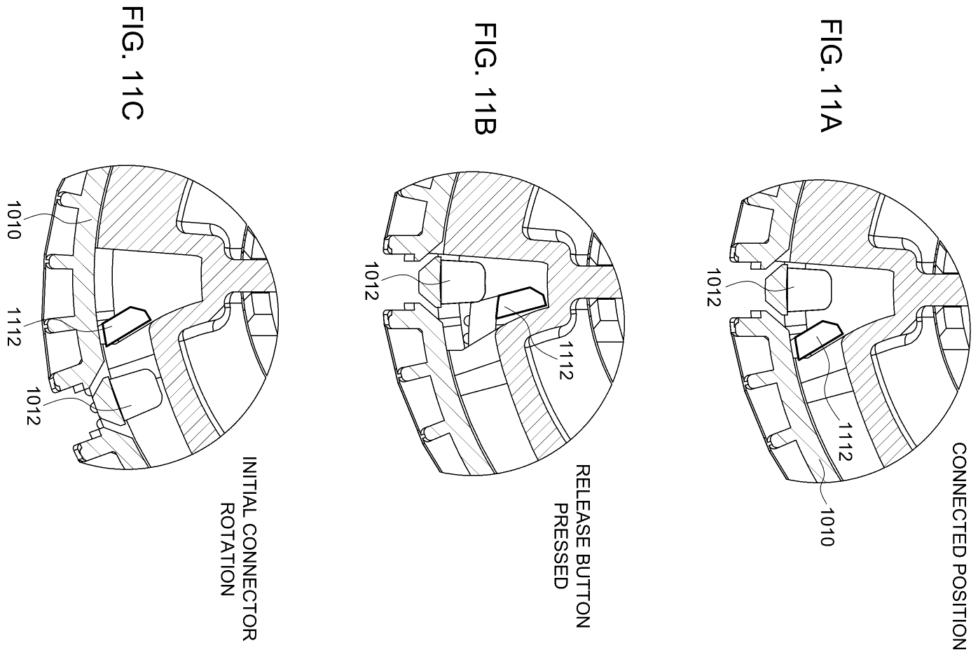

The coupling between grinder assembly 300 and the rest of machine 100 (FIGS. 4A to 4O) and the coupling 1000 between bean container 900 and grinder assembly 300 (FIGS. 10A to 12I), may be designed so that it is easy to remove and replace grinder/container assembly 110 from machine 100 without accidentally separating bean container 900 from grinder assembly 300. The coupling may permit removal and replacement of grinder/container assembly 110 from machine 100 without use of tools, or may require use of a simple tool such as a butter knife. For example, the coupling between grinder assembly 300 may be a simple vertical lift, while the container-to-grinder-assembly coupling may require a twist, depressing a release button, or tearing a tear strip. This allows the user to quickly change between bean types, without risk of cross contamination. This also prevents the user from accidentally separating bean container 900 from grinder assembly 300 prematurely which could result in spilled and/or wasted coffee beans. To that end, in some cases, release button 1110 that allows separation of bean container 900 from grinder assembly 300 may be covered by and made inaccessible by features of machine 100 when grinder assembly 300 is installed in the machine. The coupling between bean container 900 from grinder assembly 300 may permit removal and replacement of grinder/container assembly 110 without use of tools, or may require use of a simple tool such as a butter knife, or a specialized tool sold with the machine.

Apparatus 100 and grinder assembly 300 may be designed for use of other foodstuffs, such as hot chocolate and other hot beverages, nut butter, spices, etc.

A microprocessor or other controller may control timing of various operations, pressure of pumps, motors, display screens, and the like.

### II. Affixation Between Removable/Replaceable Grinder and Bean Container and the Remainder of the Grind-and-Brew Apparatus

### II.A. Non-Concentric Grinder Drive Motor

Referring to FIGS. 2E to 2F, the grinder and bean container may be removable as an assembly 110 from the rest of appliance 100.

Referring to FIGS. 4A-4B, removability of the grinder from the rest of grind-and-brew appliance 100 may be enabled by rotatable connector 450. On the outside of outer grinder housing 402 may be several raised nubs 432. Referring to FIGS. 4A, 4B, and 4C, receiving collar 420 of a stationary mounting point of the device may have recesses that receive nubs 432. Rotatable connector 450 may have one or more locking features 452 that can engage with raised nubs 432 of outer grinder housing 402. When the grinder is lowered into place, receiving collar 420 may guide nubs 432 of outer grinder housing 402 toward the locking features of rotatable connector 450. As the grinder is lowered, nubs 432 engage with the locking features 452, causing rotatable connector 450 to rotate. Rotatable connector 450 may be biased toward its original position and may rotate back to this position after nubs 432 pass below the locking features 452 of rotatable connector 450. The locking features 452 may now be engaged to prevent nubs 432 from moving upward vertically. The position of outer grinder housing 402 in all other directions (rotationally and translationally) may be fixed by the position of nubs 432 in receiving collar 420. This may be done in the same recesses of receiving collar 420 that contain the locking features of rotatable connector 450, or in separate recesses as shown in FIG. 4A. The user may remove the grinder by rotating rotatable connector 450, moving the locking features 452 to allow nubs 432 to move upward vertically, then lifting the grinder upward while holding the rotatable connector in this position. There may be, for example, eight nubs 432 on outer grinder housing 402 that engage with eight recesses in receiving collar 420—enough in number and strength to position the grinder and retain it rotationally and translationally against forces imposed by grinder drive motor 520. Referring to FIG. 4D, as the grinder assembly is lowered into receiving collar 420, gear teeth on inner grinder housing 404 may engage with gear teeth of hubless drive ring 530 (FIG. 5E) mounted below receiving collar 420. Outer grinder housing 402 may be held in place rigidly by the features of receiving collar 420 and the locking features 452 of rotatable connector 450. And then while outer grinder housing 402 is held in place, hubless drive ring 530 may be engaged to drive inner grinder housing 404. In a typical grinder drive arrangement, the grinder would engage with the grinder drive train at a small diameter, often via a central shaft. However, in this case, the engagement between the gear teeth of hubless drive ring 530 and the gear teeth of inner grinder housing 404 may occur at a much larger diameter, larger than the outer diameter of inner burr 310 and larger than the outer diameter of outer burr 312. In this case, the gear teeth of the outer grinder housing 402 are on an outer surface/diameter, while gear teeth of the hubless drive ring 530 are on an inner surface/diameter. This configuration enables a vertical fall path for grounds. A vertical fall may reduce cross contamination between different bean types, and reduce accumulation of grounds, while being very accessible for cleaning when necessary.

Referring to FIGS. 3A-3D and 4C, in order to minimize cross-contamination of residual grounds between grind cycles, grind-and-brew appliance 100 as a whole is arranged to allow the grounds to fall out of the grinder burrs directly into filter basket 700 with no chute or other collection point. In order to allow that, grinder drive motor 520 is located off the axis of the grinder burr. A series of gears, including hubless drive ring 530, transfers rotational force from grinder drive motor 520 to the inner grinder burr via inner grinder housing 404. In some cases, the user may have access to a rotatable stepped adjustment on the bottom of the grinder burr that may allow grind particle size adjustment. In some cases, a different method of grind particle size adjustment may be used. This adjustment method may require the user to remove grinder assembly 300 from appliance 100. In other cases, a feature/button may be provided on appliance 100.

FIGS. 4F to 4O show a time sequence as the grinder assembly is lowered into receiving collar 420 and locks into place. In FIG. 4F, one of the nubs 432 of outer grinder housing 402 is shown above receiving collar 420. FIGS. 4G and 4H show bean container/grinder assembly 110 lowered into receiving collar 420, just as the nub reaches a locking feature of rotatable connector 450, shown as triangle 452. Triangular locking feature 452 is spring loaded biased to the right in these figures. There may be one of these triangular locking features 452 in each recess of receiving collar 420, or there may be a locking feature in some smaller number (for example, four of eight), so long as the number of locking features is sufficient to reliably hold the grinder in place. In FIGS. 4J and 4K, as bean container/grinder assembly 110 continues to be lowered, triangular locking feature 452 is displaced to the left, against the spring bias. FIG. 4L, shows that rotatable connector 450 (with the tab at the 6-o-clock position) is rotated slightly counterclockwise. FIGS. 4M and 4N show bean container/grinder assembly 110 fully lowered and seated in receiving collar 420. Triangular locking feature 452 has returned to its original position, now retaining raised nub 432 vertically. FIG. 4O shows that rotatable connector 450 has returned to its original rotational position.

### II.B. Alternative Arrangements

In some cases, grinder drive motor 520, and any necessary gear train, may be in line on the same axis as the grinder burrs, located below. In some cases, the grinder drive may be click-engageable with the grinder burr, to engage and disengage. The centrifugal force of the spinning grinder burr may cause the grounds to fly out a side chute. Ribs that spin with the grinder may impart motion to the grounds to fling them through the chute. The bottom of the chute may be shaped on a diagonal to reduce the propensity of grounds to stick to the bottom of the chute, where they may provide cross-contamination, and may be harder to clean.

In some cases, a user may be able to turn an adjuster knob on the bottom of the grinder burr to adjust grind particle size. In other cases, a rotatable elevator dial may be provided that may raise and lower the outer stationary grinder burr relative to the inner rotating grinder burr, which adjusts grind particle size.

In some cases, outer burr 312 and outer grinder housing 402 may be driven by grinder drive motor 520, while inner burr 310 and inner grinder housing 404 are held stationary.

In some cases, grinder drive motor 520 may be on axis and above the grinder burr. Beans may be injected from slightly off-axis.

In order to capture grounds as they are flung out of the spinning grinder, and to cause them to drop straight down into filter basket 700, various non-rotating vertical surfaces may be interposed. In some cases, this vertical capture surface may be placed at the exit from the grinder. In some cases, this part may also act to retain outer burr 312 in outer grinder housing 402. This vertical surface may have a texture or ribs, to impose a bit of friction to control the grounds fall path, reducing their angular velocity and causing them to drop. In other cases, these stationary vertical surfaces may be positioned to cover rotating surfaces, such as those on the inner diameter of hubless drive ring 530, to shield falling grounds from these rotating surfaces. Due to friction and centrifugal forces, falling grounds have a higher propensity to cling to rotating vertical surfaces compared to stationary vertical surfaces. Static electricity can contribute to clinging as well. In some cases, a separate feature may be employed to address static electricity directly, such as an electrostatic ground.

### III. Water, Grinder Drive Train, and Steam Shield

FIGS. 5A and 5B show five main subsystems:
water pump 510 and heater 512
the grinder drive train from grinder drive motor 520 to hubless drive ring 530
steam shield 600 and showerhead 610 with its motor and track for guiding movement
drip valve 800 and its motor, and
a microprocessor to control all of the above.

### III.A. Grinder and Distribution of Grounds

Referring to FIGS. 3B, 3D, 5B, 5C, 5D, and 5E, because grinder drive motor 520 is located off the grinder axis, the grounds out of the grinder burr may fall directly into filter basket 700. The grinder imparts some angular and centrifugal motion to the grounds, so the fall path from the grinder may tend toward a conical shape, growing in diameter as the grounds fall downward slightly off vertical. This may tend to distribute the coffee grounds in an annulus or open-center arrangement in filter basket 700. This may in turn allow better distribution of the water, to allow more complete wetting and better flavor extraction. Because this arrangement reduces contact between the grounds and any mechanical parts, sticking, fouling, jamming, and mold growth of grounds may be reduced.

The grinder assembly may contain two bearing surfaces that allow for smooth and controlled rotational motion of inner burr 310 and inner grinder housing 404 relative to outer burr 312 and outer grinder housing 402. The first bearing surface may be a small diameter plain bearing mounted to outer grinder housing 402 above the grinding burrs. This plain bearing may engage with the central shaft which rotates with inner burr 310 and inner grinder housing 404. The second bearing surface is a large diameter plain bearing, which stabilizes the relative rotational motion between inner grinder housing 404 and outer grinder housing 402. This plain bearing may have an inner diameter that is larger than the diameter of inner burr 310 and larger than the diameter of outer burr 312. This plain bearing may also reside at an axial position that overlaps with the inner and outer burrs 310, 312. In this case, the large diameter plain bearing may be mounted to inner grinder housing 404 and rotate with it, but it could also be mounted to the stationary outer grinder housing 402. In some cases, the small diameter bearing or the large diameter bearing may be integrated into inner grinder housing 404 or outer grinder housing 402 parts directly, utilizing low friction materials for these parts.

In some cases, the grounds may be diverted into a chute that directs the grounds to fall in some other location.

FIGS. 5D and 5E are exploded diagrams, separating the parts that rotate with the inner grinder burr, from those parts that are stationary or non-rotating, including the outer grinder burr. The top component is bean container 900, a hollow container for holding the whole coffee beans. Then the next layer is the non-rotating parts, which include outer grinder burr 312, outer grinder housing 402 which includes a funnel feature to direct beans into the grinder, a small diameter plain bearing that engages with the rotating central shaft, several additional retaining and mounting components in the grinder assembly, two thin-section ball bearing assemblies 538 for stabilizing the rotational motion of hubless drive ring 530 and an intermediary gear, and the mounting components that hold these components in place relative to the appliance chassis, including receiving collar 420, rotatable connector 450, and ball bearing assembly housing. The lower part of FIG. 5D shows the rotating parts, which include inner burr 310, inner grinder housing 404, several additional components of the grinder assembly including a central shaft, spring, washers, retaining clip, and a grind size adjustment mechanism, a large diameter plain bearing, hubless drive ring 530, an intermediary gear, and grinder drive motor 520. Grinder drive motor 520 transfers energy to one or more intermediary gears, which in turn drives hubless drive ring 530, which in turn drives rotation of inner grinder housing 404 which is connected rigidly to inner burr 310.

Another anti-sticking design element is that the cylindrical wall just below inner grinder housing 404 is stationary instead of rotating. To stabilize rotation of rotating inner burr 310, hubless drive ring 530 may have sleeve 532 that projects down. Hubless drive ring 530 is supported on sleeve 532 via a ball bearing assembly 538, or other bearing, that maintains the rotating parts on axis and in its position. The stationary chassis may have a stationary sleeve 534 that nests inside the rotating sleeve 532 of hubless drive ring 530, without making contact. Sleeve 532 may ride in channel 536 via a bearing 538. Because the stationary sleeve 534 is presented on the inside, when the grounds emerge from the grinder burrs, they hit stationary sleeve 534, and the stationary sleeve slows their velocity so that they can fall into filter basket 700, with reduced sticking to the wall. Without stationary sleeve 534, the grounds may cling to the wall of the rotating sleeve 532 due to friction, centrifugal forces, and in some cases, static electricity.

Referring to FIGS. 5F-5H, though the goal is for the grounds to drop more or less straight down, at high grinder speeds, centrifugal forces may cause the grounds to emerge horizontally enough to get stuck in some of the rotating parts, such as at the gap between the rotational and stationary housing, or in spokes that connect the inner and outer portions of inner grinder housing 404. The inner portion of this housing may mount inner burr 310, while the outer portion may be designed to transfer rotational energy from hubless drive ring 530. To reduce sticking (material build up), connecting spokes 560 of inner grinder housing 404 may be shaped as angled fan blades. The grounds exhibit significantly less sticking to angled spokes 560 than with vertical spokes. Angled spokes 560 follow the path of the grounds, passing by the grounds as they fall, while vertical spokes intercept the grounds, pushing them outward where they cling to rotating surfaces due to centrifugal forces and friction. Alternatively, angled fan blade spokes 560 could be part of hubless drive ring 530 (which would then no longer be hubless), and the engagement between inner grinder housing 404 and hubless drive ring 530 could occur at a much smaller diameter, smaller than inner burr 310 and outer burr 312, possibly as a central shaft. While this is simpler in some regards, it may create more cross-contamination and may reduce cleanability.

### III.B. Heating of Water

In parallel with the grinding, water heater 512 may heat the water to be injected.

### III.C. Steam Shield and Showerhead

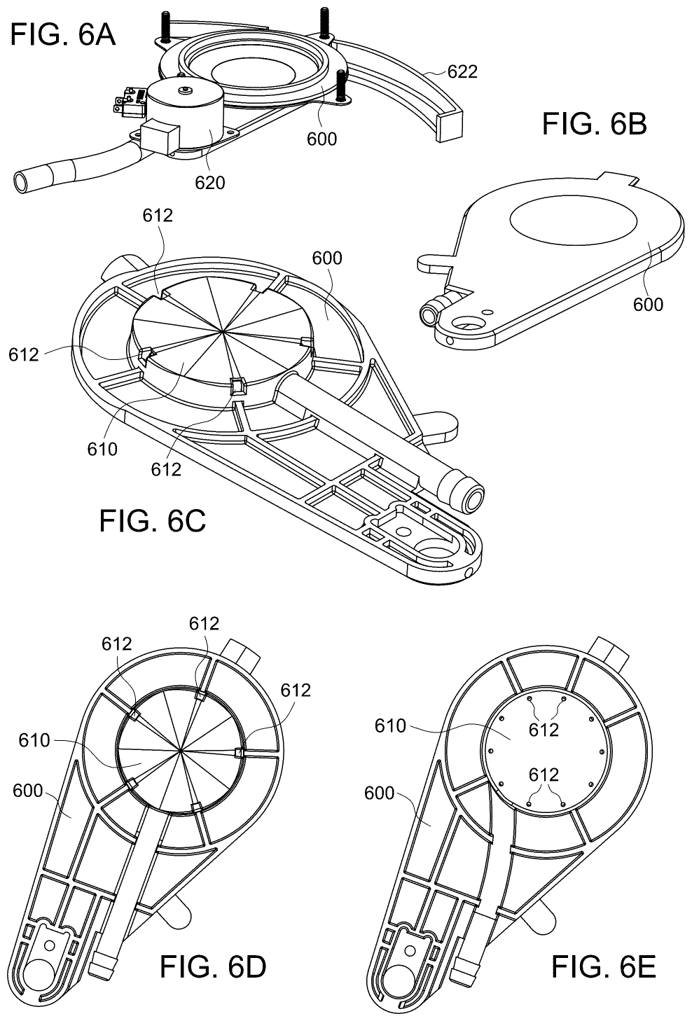

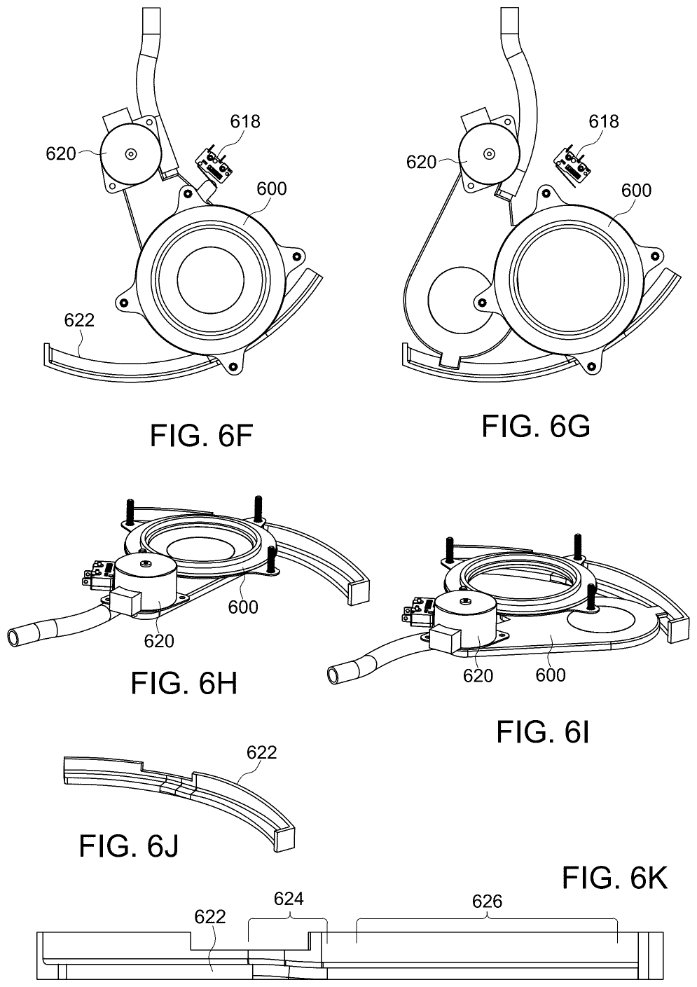

Referring to FIGS. 6A to 6K, the grinder may be shielded off from the brewing chamber of grind-and-brew appliance 100 once hot water is introduced. Reducing infiltration of steam and other water vapor into the grinder and fall path may reduce sticking and clogging, and other undesirable effects on the coffee and grounds such as mold growth and reduced freshness.

Referring to FIGS. 6A, 6B, 6F, and 6G, steam shield door 600 may lie between filter basket 700 and the grinder. Steam shield 600 may pivot away from the brewing path during grinding, to allow grounds to fall from the grinder burr into filter basket 700.

When grinding is complete, the controller may allow a short time for grounds to finish falling from the grinder into filter basket 700. The controller may run the grinder in reverse for a brief moment, a half second or so, to dislodge residual grounds to fall into filter basket 700. This reverse run may reduce the amount of residual grounds that get stuck in grinder assembly 300, and the loose grounds that may fall out when grinders are swapped out and provide a means to clear the burrs of grounds. A short reverse run may reduce mess, cross-contamination, and undesirable build up of grounds.

The controller may then issue a control signal to the steam shield motor 620 to close steam shield 600.

Referring to FIGS. 6C, 6D, and 6E, the underside of steam shield 600 may have showerhead 610 designed to distribute hot water onto the grounds. Hot water flows through distribution openings or passages 612 and falls onto the grounds to extract brewed coffee. Brewed coffee flows through screen mesh 720 of filter basket 700. Placing showerhead 610 on the bottom of steam shield 600 may reduce part count and complexity, and may allow multiple distribution openings 612 to be distributed over an area, so that water is not injected at a single point location. The diameter of the points at which water lands on the grounds may be on the inner side of the annulus/volcano of grounds that fall from the grinder. Distributing water injection over an area may result in more even wetting of the grounds, and more complete extraction of coffee from the grounds. Having showerhead 610 (on the bottom of steam shield 600) in an off-axis position during grinding allows the coffee grounds to fall straight from the grinder burr into filter basket 700, which reduces cross-contamination between brews if users swap out different beans. Moving showerhead 610 to an off-axis position enables the showerhead water distribution pattern, via the multiple distribution openings, to match the distribution pattern of fallen grounds in size and shape, in this case, an annulus shape. Then showerhead 610 may move to an on-axis location to distribute hot water. In some cases, showerhead 610 and steam shield 600 may be separate parts. In this case, they may move together, but may be thermally insulated or mechanically separated to reduce the thermal mass of showerhead 610 and the associated heat loss as hot water flows through it.

The water intake channel may flow radially into a distribution manifold to the distribution openings, shown in FIG. 6D. In an alternative, shown in FIG. 6E, the water intake channel may enter the distribution manifold 612 tangentially to reduce turbulence. By reducing turbulence, pressure and flow though the distribution openings 612 may be equalized, which may in turn result in more even wetting of the grounds.

Steam shield 600 may move between an open position that allows grounds to fall out of the grinder burr into filter basket 700 (FIGS. 6G and 6I) and a closed position for distribution of hot water and brewing (FIGS. 6F and 6H). Coupling steam shield 600 and showerhead 610 reduces problems of control timing and sequencing-it guarantees that when water is injected, steam shield 600 is closed.

Referring to FIGS. 6J and 6K, the moving end of steam shield 600 may ride in a track 622. Track 622 provides support for the steam shield 600, which is supported at the motor end and at the track end, so neither end needs to support cantilever forces. Track 622 may have a little rise portion 624. Closing of steam shield 600 may begin when grinding is complete. For most of its arc of travel 626, steam shield 600 may be a millimeter or two below the gasket that closes off the grinding chamber. Rise 624 may be aligned a few millimeters from the end of the arc of travel into closed position, so that the distance moved while steam shield 600 is fully sealed and at its highest frictional load is reduced. As steam shield 600 reaches its closed home position, it may contact a position sensor switch 618. The home position sensor may signal a controller to turn off steam shield rotation motor 620, and call for injection of water. The controller may signal water pump 510 and heater 512 to begin heating water earlier for efficiency, however the controller will limit pump 510 so that water does not exit showerhead 610 until steam shield 600 is in its home position.

This home position sensor switch 618 may also facilitate grind-and-brew appliance 100 to regain operational stability at startup. For example, if power is shut off in the middle of a cycle, this home switch may assist the controller to reestablish an understanding of the current location of steam shield 600. On power up, the controller may check to see whether the home position switch is closed, and if it isn't, the controller may direct steam shield door 600 to close.

The controller may be programmed for different styles of coffee. For example, a drip Americano may be prepared by initially brewing an espresso or other very strong cup of coffee in a short period of time, and then that strong coffee may be diluted by adding water. This additional water may be distributed via showerhead 610, or via an additional water outlet that distributes water directly to the coffee mug or other drinking vessel without passing through the ground coffee.

The water distribution openings 612 may be slightly angled, and water pump 510 may pulse the feed water pressure, which may vary the radial distribution of water from openings 612, which may further disperse the water over a larger area. The control system may be programmed to oscillate steam shield 600 slightly during the brew cycle, which may further distribute the water to wet the grounds more evenly. The shape of showerhead 610 and/or steam shield 600 may be modified to a bean shape to accommodate this oscillating movement to maintain a seal throughout the oscillation. Pressure and flow of water pump 510 may be strategically cycled between on, high pressure, low pressure, and off, to allow filter basket 700 to flood and drain for more efficient extraction. The controller may be programmed to control the water flow to optimize extraction. For example, it may be desirable to inject about 40% of the water (or some fixed cubic volume) up front, then pause to allow residence time between the water and the grounds, before injecting more water. Then the water may be added in five-second-on-five-second-off periods. This may allow time for the water to drain through a flood and drain process repeatedly. This method of brewing may be closer to a pour-over style than a typical drip coffee machine, but may also have elements that are different from either.

Steam shield 600 may consume a large horizontal footprint, because (a) to cover filter basket 700 that is relatively large (to allow for variability in cup size), covering steam shield 600 may be similarly large in order to distribute water evenly, (b) to receive grounds falling directly from the grinder with no intermediary channel or chute, the diameter of the opening between the grinder assembly and filter basket 700 should be as large as the fall pattern out of the grinder burr, and (c) horizontal footprint may be required to permit steam shield 600 to move between its closed an open positions. Steam shield 600 may be large enough to cover the entire opening to protect the grinding area from rising steam. In some cases, steam shield 600 may pivot inward toward the back of the brewer, instead of toward the front or side of the brewer. The large footprint of steam shield 600, explains the need for showerhead 610 to move with steam shield 600, as a stationary showerhead would have to be located significantly off center of filter basket 700, resulting in uneven wetting of the grounds.

In some cases steam shield 600 may be formed as a butterfly of two halves that open. In some cases steam shield 600 may have alternating cutouts like a piano hinge to allow a separate water inlet tube to reside in steam shield 600 without adding to the overall height. In some cases steam shield 600 may be formed by two semi-circles that pivot or translate open.

### III.D. Filter Basket Assembly

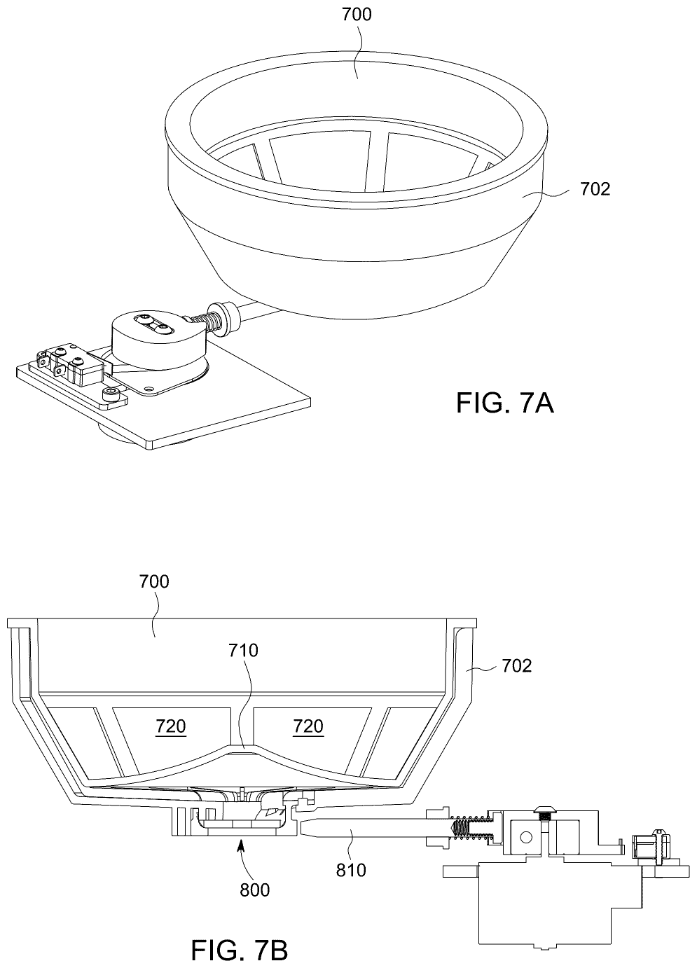

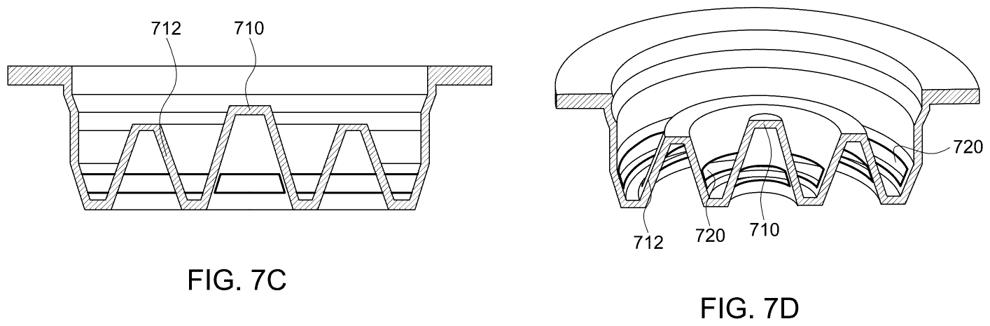

Referring to FIGS. 7A to 7D, filter basket 700 may be designed to improve flow of water through the coffee grounds. Filter basket 700 may be designed to increase surface area per unit of volume of coffee. Filter basket 700 may be designed to improve contact time between the water and the grounds. Filter basket 700 may be designed to promote a water flow path that utilizes all grounds efficiently. Filter basket 700 may be designed to prevent water from traversing a path of least resistance where it can quickly pass through filter mesh 720 without sustaining sufficient contact time with grounds, to allow variable size cups (typically from 6 oz (175-200 ml) to 18 oz (500-550 ml)) with the right ratio of grounds to water (for example, a greater ratio of grounds to water if the user wants a stronger cup of coffee). Filter basket 700 may be designed to reduce stack height so that grind-and-brew appliance 100 as a whole may allow tall mugs and fit under 17-inch standard cabinet heights.

The inner diameter of filter basket 700 may be −4.25″ in diameter and −1.75″ in height. To reduce stack height, the ratio of the diameter of filter basket 700 to height may be relatively large relative to other coffee makers that produce a similar volume of coffee. This diameter to height ratio may be about 1.5 to 1 or larger, 1.8 to 1 or larger, 2 to 1 or larger, about 2.4 to 1 or larger, about 3 to 1 or larger, about 3.5 to 1 or larger, about 4 to 1 or larger, about 4.5 or larger, or about 5 to 1 or larger (for example, in FIGS. 7B and 7C, the inner dimensions of filter basket 700 are about 2.5 to 1). A cone uplift in the center of filter basket 700 may improve extraction efficacy with small amounts of ground coffee, by confining the ground coffee in a relatively small volume at sufficient density to slow the through flow of water and increase contact time to ensure good extraction of flavor and dissolved solids. For all ground amounts, the center uplift urges water through the grounds to the filter screen at the side of filter basket 700. The center uplift may be a solid wall, with no filter mesh 720, which reduces exit of water that has not travelled through grounds. In some cases, the center uplift may contain filter mesh 720, but water is not able to pass through it when installed in brew basket 702, because solid walls of brew basket 702 are flush against filter mesh 720 of filter basket 700, blocking the passage of water. In this case, the center uplift contains filter mesh 720 to aid the user in cleaning filter basket 700 after the brew process, allowing for water to pass through from the other side, washing away used ground coffee. Because the grounds coming out of the grinder burr tend to fall in an annulus, they tend to fall into the outer (and vertically lower) parts of filter basket 700. The center cone uplift routes water flow to the grounds in that location. The center of the annulus shape receives very few to no grounds and without the center cone uplift, water would accumulate in this center region without passing through grounds, resulting in suboptimal extraction and inconsistent coffee cup volumes.

Referring to FIGS. 7C and 7D, in some cases, filter basket 700 may have multiple features that provide wall space for through-flow screens. The amount of flow-through space may be designed to hold the water in contact with the grounds for an appropriate time. The overall volume may be designed to hold an appropriate amount of grounds to make one large, strong cup of coffee, and then the user may set controls to deliver less coffee. In some cases, filter basket 700 may be a cone or frustum of a cone, with the amount of solid wall and through-flow screens balanced to give proper contact time between the water and the grounds. In some cases, the flow screens may be on the outer generally-vertical wall of the filter basket. In some cases, the flow screens may be in the flat bottom of the filter basket, arranged generally at the periphery, to allow the water to flow through, to minimize stranding of water in the filter basket. In some cases, filter passages on the bottom of filter basket 700 may be covered for the first portion of the brewing time, to force the water though the filters on the sides, and then opened after a time to allow all water to drain out.

In some cases, the components may be designed to promote air flow that distributes aroma into the room where grind-and-brew appliance 100 is operated. In some cases, a fan may be driven by one of the motors. The built-in fan of one of the motors may be oriented to provide this function. The aromas and steam resulting from the brew process that are blocked by steam shield 600 may be routed toward the user and may be dispersed by a fan.

Referring to FIGS. 7A, 7B, 7C, and successors, filter basket 700 may be designed to optimize among several parameters. The filters or filter mesh 720 should be placed so that water has to flow through the grounds, rather than flowing through a part of the filter that has no coffee grounds interposed. The flow should be reasonably fast, to reduce brewing time, but slow enough to allow sufficient extraction through contact time with grounds. The amount of grounds may be variable, depending on the cup size and strength setting selected by the user. The geometry of filter basket 700 and filter mesh 720 pattern may be designed to allow for consistent and optimal brew quality across the full range of possible amounts of grounds. Vertical stack height should be kept small, to allow grind-and-brew appliance 100 as a whole to fit under a standard 17-inch cabinet height. A number of variations may be considered, with overall shape ranging from a flat bottom to a down-ward-pointing cone, to a flat bottom with a raised volcano in the center, to a series of nested up-and-down conical frusta, with filters on a flat bottom (or a solid bottom), with filters on the side, with multiple nested cones and filters on the sides of each cone, with filters confined to the lower part of the side, or extending much of the way up the side. After modeling and testing, a shape with a raised-cone solid bottom, and filter panels on the side was chosen to balance these concerns.

A disposable, single-use filter, made of paper or some other porous material, with a raised center may be utilized as well. In some cases, such a paper filter may be sold for use with a filter basket shaped as shown in FIGS. 7A, 7B, 7C. In some cases, this single-use paper filter may be placed inside and on top of filter basket 710 or it could be placed directly into outer basket 702, replacing the filter basket. In other cases, these filters may be sold for use in conventional flat-bottomed filter baskets, and sold with a solid object, for instance in the shape of a frustum of a cone, that may be placed in the center of a conventional flat bottom basket. This single-use filter may have a raised bottom and a relatively large diameter to height ratio. The width to height ratios discussed above may be used with this paper filter. By distributing the grounds in an annulus, such a filter increases the time during which the water is in contact with the grounds, which tends to improve extraction, which in turn alters the flavor blend. This single-use filter eases the process of cleaning for the user as they can simply lift out the filter and dispose of the grounds along with the filter.

### III.E. Drip Valve

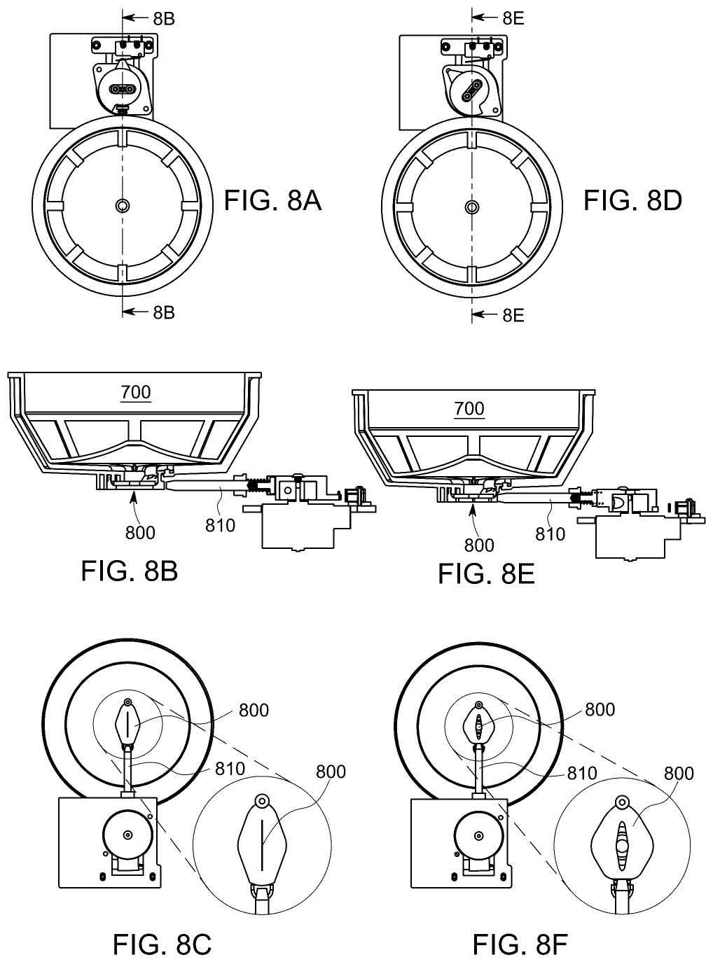

Referring to FIGS. 8A to 8F, filter basket 700 rests in an outer brew basket 702, which may be slightly conical to collect the brewed coffee and route it to a flow/drip valve 800 which allows the coffee to flow into a cup. To allow use with the user's choice of cup (rather than a fixed-configuration carafe with a top specially designed to open a flow valve 800), outer brew basket 702 may have a normally-closed valve 800. Valve 800 could be opened via a motor during the brew cycle to allow coffee to flow from inner filter basket 700 into the user's cup. Valve 800 closes when brewing is complete (with some delay after pump 510 turns off to allow the water to complete its flow through) to allow carrying of outer brew basket 702, inner filter basket 700, and grounds to the trash for removal of grounds without dripping of residual liquid coffee. Valve 800 may be opened and closed via a motor and cam. Valve 800 may be a simple slit/bite valve in a temperature-stable deformable plastic such as silicone. To open valve 800, the cam may push a spring-loaded actuator rod, which presses on valve 800 or valve mechanism from the side, deforming valve 800 itself, or moving levers 810 that cause valve 800 to open. Valve 800 may be any other form of valve, most likely one that is normally closed to limit dripping at rest or during grounds the disposal process.

By providing valve 800, grind-and-brew appliance 100 may give a clear cutoff that indicates the end of the brewing cycle (rather than requiring a user to simply observe when coffee stops dripping into a typical carafe brewer). Valve 800 may also control the last bit of coffee, to ensure that brewed coffee that might be over- or under-extracted is withheld from the cup.

In some cases, motor 620 that powers steam shield 600 may be the same motor that powers the drip valve actuation. In this case, steam shield 600 may have additional positions to allow for performance of different features. In some cases, steam shield 600 may be bean shaped, to allow it to travel in an arc, while sealing below the grinder and over the circular brew chamber in multiple positions.

In some cases, simple slit/bite valve 800 may be formed from a temperature-stable deformable plastic such as silicone. Valve 800 may have a bellows or accordion fold to allow for more freedom of movement for valve 800 during actuation. Additional ribs may help direct the flow of coffee to valve 800. The bellows or accordion fold may encircle greater or less than 180° of valve 800. Valve 800 may be a spring-loaded mechanical valve instead of a simple slit/bite valve made of deformable plastic. A mechanical valve 800 that may be actuated by a translating rod 810 and/or by a pivoting lever. The rod or lever 810, in turn, may be controlled by a motor and cam system. A mechanical valve 800 may be normally closed due to a spring that rotates a lever arm.

### IV. Bean Container

Bean container 900 may be formed as a generally cylindrical aluminum can. Bean container 900 may have a bottom that is funnel shaped. Container 900 may have a maximum capacity of, for example, 4 oz, 5 oz, 16 oz, 24 oz, or 32 oz of whole coffee beans, or a single-serving size (see § IV.F starting at ¶ [0098] below), or 8 oz, 12 oz, or 16 oz of nuts. In some cases, it may be desirable to conform the size of container 900 to package sizes generally sold at retail. Smaller sizes may contribute to preserving freshness, larger sizes may contribute to the convenience of less-frequent refilling or replacing of the container. Some containers may be transparent (so the user can see how many beans remain in container 900). Other containers may be opaque. In some cases, the connector between the grinder and the reusable bean container may be sufficiently convenient that two users may share a single grinder that they move between two reusable bean containers. In other cases, bean container 900 and grinder may be connected in a “cassette” assembly 110 that is conveniently removed and replaced cup-to-cup, as discussed above in connection with FIGS. 1A to 1F, 4A, 4B, and 4F-4O. In some cases, the grinder and reusable bean container may be a single part with a cap that can be removed to add more beans and placed back on to keep the beans fresh.

### IV.A. Reusable Bean Container

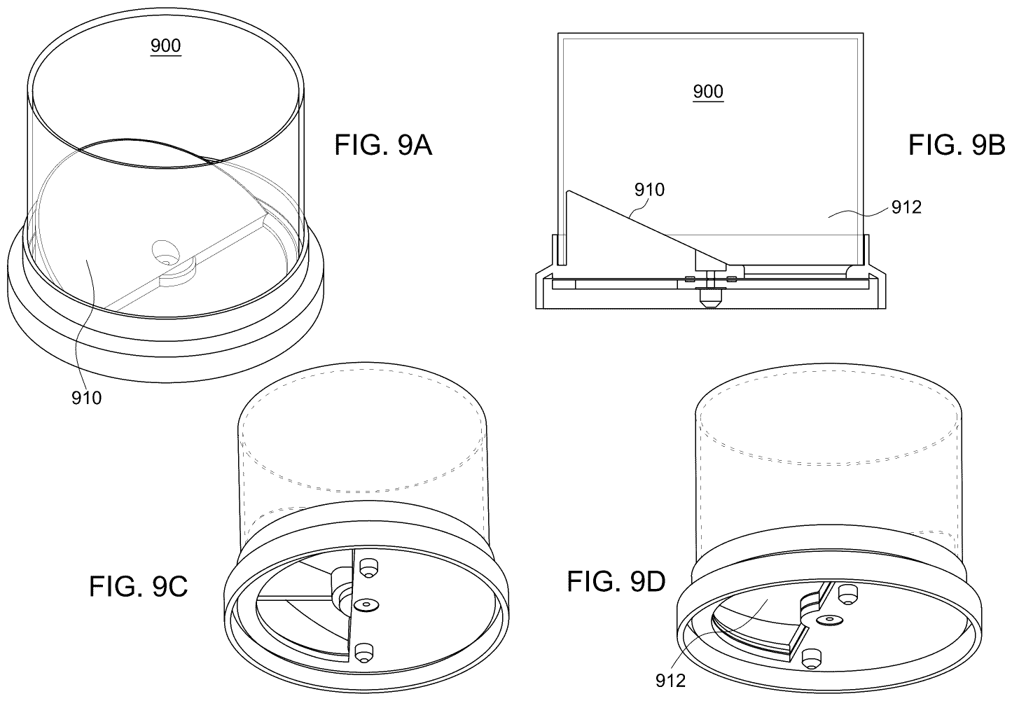

In some cases, bean container 900 and grinder may be designed so that container 900 can be refillable. For example, in FIGS. 9A-9D, the bottom of bean container 900 may be designed to rotate between closed and open positions. In the closed position, container 900 confines the beans for transport and storage, and protects the beans from moisture and other intrusions. In the open position, ramp 910 allows the beans to flow through an opening 912 into the grinder. In some cases, opening of this rotatable door may require engagement with an opening feature and mechanism on the grinder. This may protect against accidental opening and spillage.

In some cases, bean container 900 and grinder may be designed as a single part or assembly, where bean container 900 is incorporated into the grinder assembly and is refillable.

### IV.B. Single-Use Bean Container Using Mechanical Keyed Features

Referring to FIGS. 10A to 13J, a connector 1000 between bean container 900 and grinder assembly 300 may have mechanical features to restrict bean container 900 to a single use of multiple servings before disposal or recycling. In this case, single use allows for multiple servings, but deters or prevents filling of the container for further use. Container 900 may have a container-side connector collar 1010. Container-side connector collar 1010 may be a part of container 900, or it may be assembled to it. FIG. 10C is a cross section looking through container-side connector collar 1010 with snap features 1012. FIG. 10C shows one snap feature 1012 on the right, one on the left, and one in the center. FIG. 10D is a cross section through container-side connector collar 1010 showing snap feature 1012, and FIG. 10E is a perspective view showing snap feature 1012. Snap feature 1012 and mating recesses 1014 in container-side connector collar 1010 have angled surfaces in parallel mating to each other. These angled features will be used to push snap feature 1012 through slots in container-side connector collar 1010 in a way that either locks components into an inoperative position, deforms components, or breaks components, or otherwise leads to deformation that ensures single use.

Bean container 900 may be sold to the consumer with container-side connector collar 1010 already attached. Referring to FIGS. 1G, 1H, 10A and 10B (FIGS. 10A to 10F are upside-down relative to a consumer's actual use, for consistency with the rest of the figures), to install a grinder onto container 900, the consumer may begin by placing container 900 upside-down on a table surface. The consumer may remove a protective cap that covered the bean opening during shipment and storage. The consumer may then remove a foil seal or can ring end that covered the opening to preserve freshness of the beans. The foil seal, container-side connector collar 1010, and the bottom face of container 900 may be designed so that the foil seal can be removed—for example, the engagement surfaces between container 900 and container-side connector collar 1010 may be arrayed around the outer periphery of container 900, rather than on the face of the container opening, so that the foil seal is easily removed. The consumer may lower grinder assembly 300 with its male threaded grinder-side connector 1020 facing the thread like features of container-side connector collar 1010. The consumer may push grinder assembly 300 down to lock bean container 900 assembly and grinder together.

Referring to FIGS. 10A to 10F, various components interact during the process of connecting the halves of connector 1000. FIGS. 10A to 10F show the assembly turned right-side-up, with container 900 on top and grinder assembly 300 on the bottom, even though the actual connection would be formed with the parts upside-down to prevent beans from spilling from the container. In these views container 900 is being lowered onto the grinder. The container-side connector 1010 and grinder-side connector 1020 may have lead-in features that guide the two parts into correct alignment with each other. FIGS. 10B to 10F show snap feature 1012 of the container-side connector 1010 in its neutral position before it contacts mating features on grinder-side connector 1020. In FIGS. 10G and 10H as grinder assembly 300 is lowered to container 900, bevel 1030 of snap feature 1012 on container-side connector 1010 has just touched and is just starting to engage with beveled feature 1032 of grinder-side connector 1020.

In FIGS. 101 and 10J, as container 900 is lowered further, bevel 1032 of grinder-side connector 1020 displaces snap feature 1012 outwards. In FIG. 10J, snap feature 1012 is bent out as bevel 1030 rides over bevel 1032 of grinder-side connector 1020. In FIGS. 10K and 10L, the two sides 1010, 1020 of connector 1000 are fully engaged, and snap feature 1012 has passed bevel 1032 of grinder-side connector 1020, and has snapped back to its neutral position, which locks 1040 the both halves of the connector together, which in turn locks together container 900 and the grinder.

In FIGS. 10G to 10L, as container 900 and grinder assembly 300 are brought together, actuator 1050 translates vertically and is depressed against a spring. This displacement may be read by a sensor to ensure that a bean container is in place before power is applied to the grinder, as a safety lockout. This may also protect against counterfeit components or attempted reuse or refilling of bean containers.

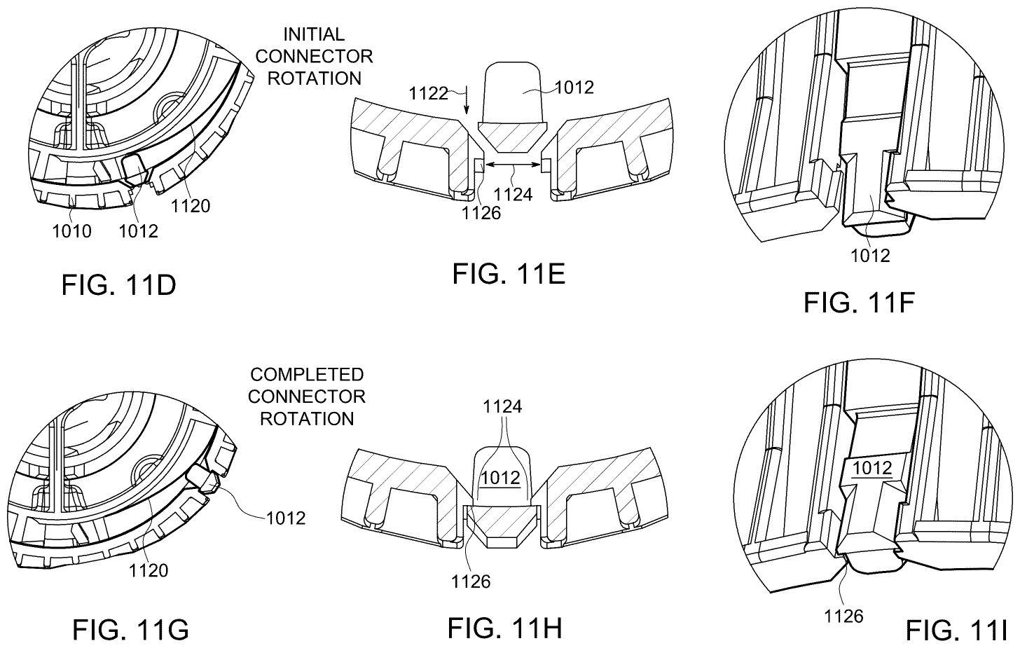

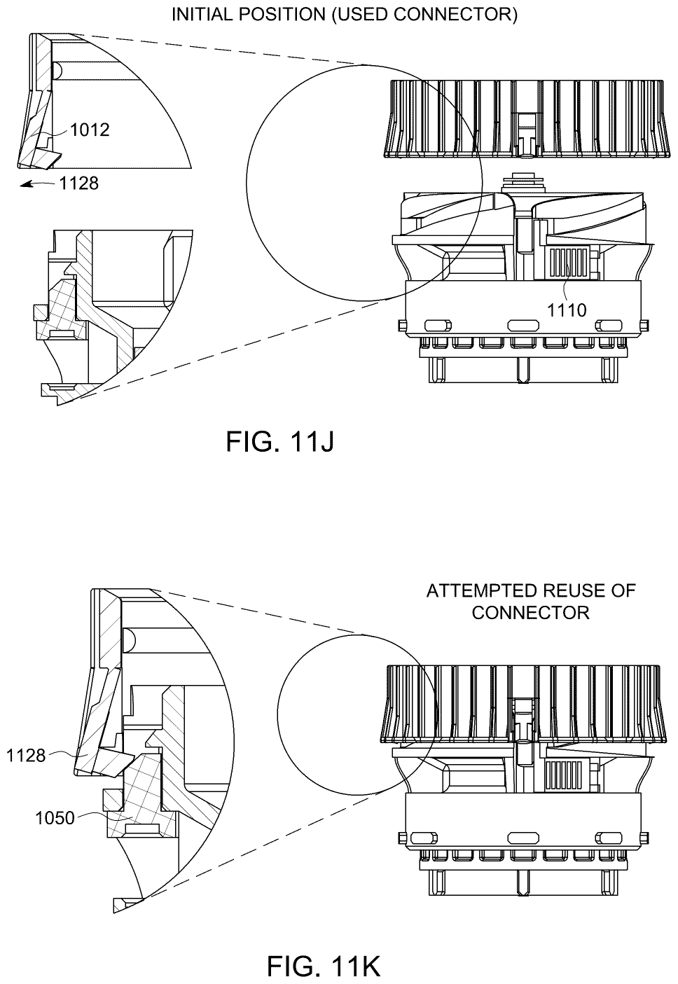

FIGS. 10K and 10L show the fully connected position. In this position, the consumer can use the grinder to grind the beans from container 900 through the brewer for multiple servings, until container 900 is empty. FIGS. 11A to 11K show removal of container 900 from the grinder, and the activation of the one-time use feature.

Referring to FIGS. 10K, 10L, and 11A, when the two halves of the connector are mated, snap feature 1012 holds bean container 900 and grinder stationary relative to each other by engagement at 1040. The column of snap feature 1012 may be unable to rotate either clockwise or counterclockwise because it is blocked by release button 1112. Rotation of snap feature 1012 may be prevented in the other direction by features of the grinder-side connector 1020. The two halves of the connector cannot separate vertically because of the snap engagement 1040 shown in FIG. 10L. Externally-visible release button 1110 is connected to internal boss 1112, shown as a bold trapezoid in FIG. 11A. When release button 1110 is in its neutral state, boss 1112 is lodged against the outer collar of container-side connector 1010, which blocks passage of the column of snap feature 1012, to provide rotational locking. Release button 1110 is spring loaded to this neutral position.

Referring to FIG. 11B, when the beans in container 900 are exhausted, the consumer removes container/grinder assembly 110 from the brewer. The consumer presses release button 1110, which moves boss 1112 radially inward, which opens a channel for rotational passage of the column portion of snap feature 1012. Then the consumer twists container-side connector collar 1010 relative to grinder-side connector 1020. In FIG. 11C, collar 1010 and snap feature 1012 have rotated 10° from the locked position of FIGS. 10K and 10L, and release button 1110 has been released, so locking boss 1112 has moved back to its neutral position.

Referring to FIG. 11D (with reference to FIGS. 11E and 11F), grinder-side connector 1020 may have an increasing-radius ramp surface 1120. As the consumer continues to rotate container-side connector collar 1010, the column of snap feature 1012 rides ramp 1120. This motion pushes snap feature 1012 outward (arrow 1122).

Referring to FIG. 11G, when container-side connector collar 1010 has been rotated about 30°, snap feature 1012 is pushed 1122 past constriction 1124 located on container-side connector collar 1010, and reaches landing zone 1126. Referring to FIGS. 11G to 11J, features 1126 of snap feature 1012 and container-side connector collar 1010 retain snap feature 1012 in radially-extended position 1128.

From the snapped out, radially-extended position 1128 of FIGS. 11G, 11H, and 11I, snap feature 1012 is designed to be unable to reengage the retaining features of grinder-side connector 1020. The walls of landing zone 1126 may extend outward to prevent manual forcing of snap feature 1012 back through the constriction 1124 of container-side connector collar 1010 so that snap feature 1012 of container-side connector 1010 cannot reengage with the mating feature of grinder-side connector 1020 (contrast FIGS. 10K and 10L against FIG. 11K). Likewise, with snap feature 1012 retained in radially-extended position 1128, it cannot engage with actuator 1050 to depress it. Because actuator 1050 is not depressed, the sensor does not detect presence of a container above the grinder, and thus the controller will not allow power to be applied to grinder 310.

Connector components 1000 may have one or more of the following advantages. Container-side connector collar 1010 may spin freely on the neck of container 900, which may make it easier for the consumer to engage the threads of container-side connector 1010 with the threads of grinder-side connector 1020. In contrast, the process of removing container 900 from the grinder may be relatively difficult, requiring the consumer to simultaneously depress release button 1110 and rotate container-side connector collar 1010. Because once it is removed, bean container 900 cannot be reconnected to the grinder (and the beans cannot be used, or might spill out), accidental removal should be prevented, and so the act of disconnecting should require intentionality (analogous to a child-resistant cap on a drug container), such as two motions simultaneously. Because container-side connector collar 1010 may spin freely on the neck of container 900, accidental or uninformed rotation of the container 900 relative to the connector collar 1010 and/or grinder 300 will not cause damage or unintended disconnection of container 900 from grinder 300. This free spin may also allow the user to align the container 900 to their preference once installed in the appliance 100, for example with container branding and graphics facing forward.

Likewise, container-side connector collar 1010 may extend to cover much of the connector mechanism in both container 900 and the grinder, to prevent consumer confusion and tampering.

A single-use coffee bean container 900 that contains multiple servings may use multi-layered, multi-material bags (often non-recyclable) containing up to 32 oz of whole coffee beans.

In some cases, container side connector collar 1010 may be separable from the container 900 by the user so that they can be recycled independently if they are different materials. This may be done by squeezing or deforming (permanently or temporarily) features of container 900 or container side connector collar 1010. Another separation method may be used as well. Grinder side connector 1020 may have features that block this separation action when container side connector collar 1010 is installed on grinder 300. This requires that the user separate the connector collar 1010 from the grinder 300 first, activating the one-time use feature. This prevents the user from separating container 900 from connector collar 1010 while it is attached to grinder 300, then refilling container 900 and reattaching it to the connector collar 1010.

### IV.C. Single Use Container Using Tearing

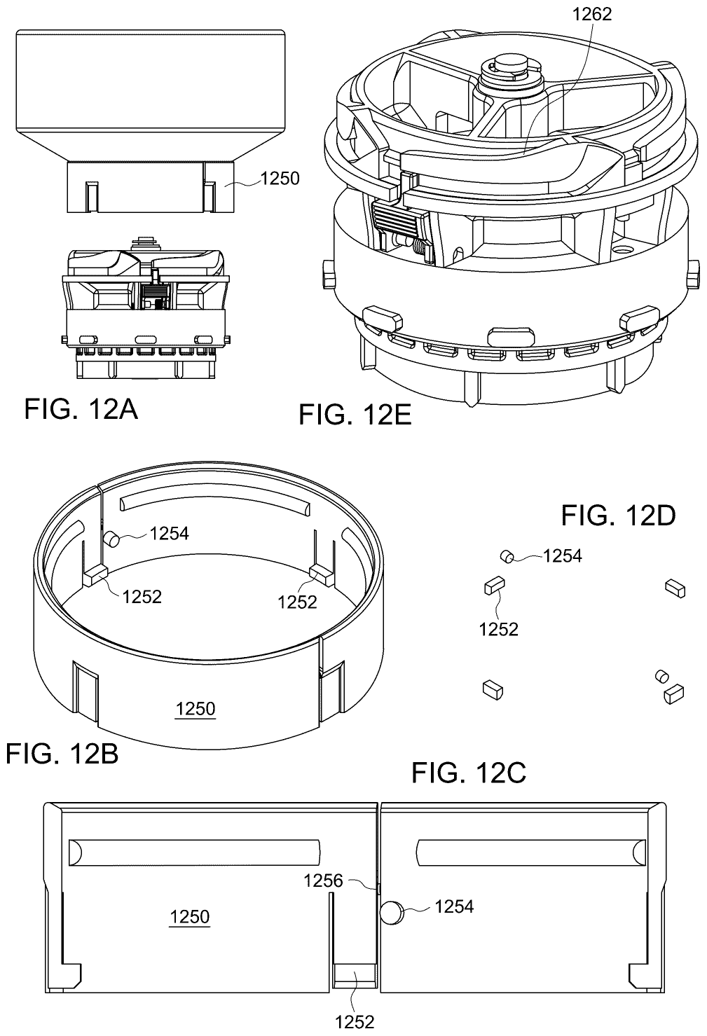

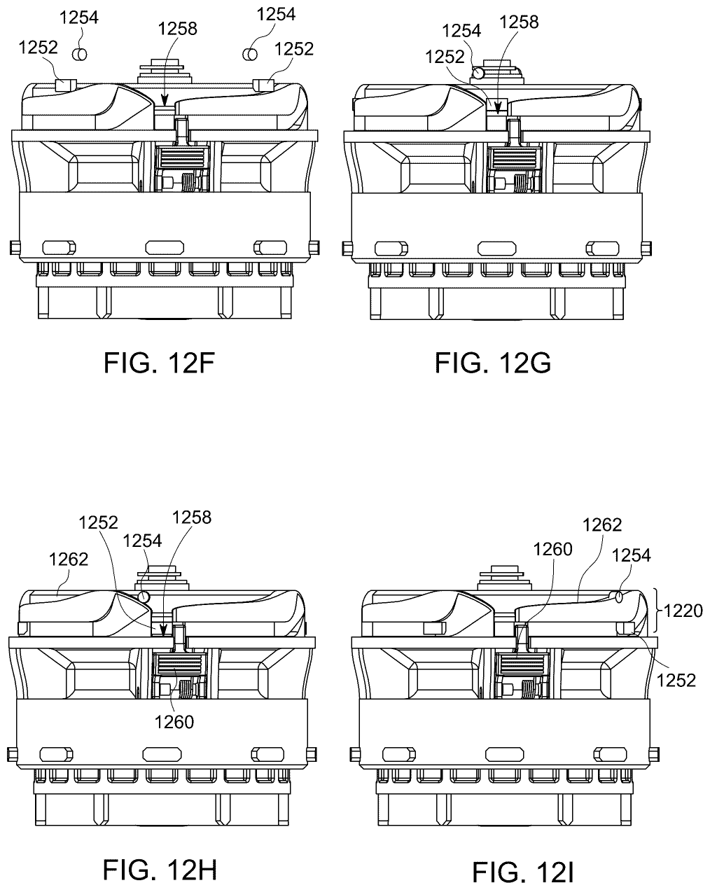

Referring to FIGS. 12A to 12I, single-use feature may be accomplished via a connector that tears as it is disconnected. FIGS. 12A, 12B, 12C, and 12D show a collar 1250 that may be connected to a neck of bean container 900. Container-side connector collar 1250 may have rectangular features 1252 that slide into mating features of grinder-side connector 1020 during connection. During disconnection, circular features 1254 of container-side connector collar 1250 ride the grinder-side's ramp features 1262 to stretch components 1256 of container-side connector collar 1250 to deformation and yielding.

In FIGS. 12F and 12G, during connection, container-side connector collar 1250 is rotated until rectangular features 1252 of collar 1250 engage with vertical slots 1258 of grinder-side connector 1020, and then the grinder is brought into engagement with bean container 900. In FIG. 12H, rectangular features 1252 of container-side connector collar 1250 engage with vertical slots 1258 of grinder-side connector 1020, to hold bean container 900 securely and in its operating position.

Referring to FIG. 12I, when bean container 900 is empty, the consumer presses release button 1260. This allows rectangular features 1252 of container-side connector collar 1250 to rotate (to the right in FIGS. 12H and 12I). As collar 1250 rotates, circular features 1254 ride ramp 1262. Ramp 1262 forces round feature 1254 and rectangular feature 1252 to separate. This increasing distance causes a link 1256 within container-side connector collar 1250 to fail, so that collar 1250 releases from grinder-side connector 1020 and the permanent failure guarantees that collar 1250 and bean container 900 cannot be reused. The number of round features 1254 and links 1256 may be the same as the number of rectangular features 1252, or there may be fewer. When link 1256 is broken, the connector collar 1250 is separated from the container 900, either as one piece or as multiple pieces. This allows connector collar 1250 and container 900 to be recycled separately. This separation also breaks the connection between the grinder and container, allowing them to be separated.

### IV.D. Single-Use Bean Container Using Short-Range Radio Communication

In some cases, the brewer may have a near-field communication (NFC) reader, RFID reader, or similar short range radio communications, and each bean container may have a readable tag. The technology may be RFID tag, ISO/IEC 13157, ISO/IEC 18000-3. The tag may be affixed to bean container 900 by an adhesive back, or by embedding in the connector mechanism.

The tag may record the farm that the beans came from, date the beans were harvested, the roaster, the roast type, date of roast, and similar characteristics of origin. Information stored in the tag may be used for user inventory tracking and reordering. The reader in the brewer may confirm that bean container 900 is a non-counterfeit container, and is not being reused beyond its intended single use of multiple servings lifetime. The tag may record a capacity of container 900, so that a lifetime can be computed. A computer on the brewer may record how many times a given container has been used, or total grind time with a given container. The total grind time may be used to compute reorders as the consumer uses the beans. This may ensure that the beans are delivered to the consumer just in time, to ensure freshness. The computer can inform the user how many beans are left in the container and warn when it is running low on beans.

The tag may record the type of bean in container 900. The tag may include information that acts as a key to lock or unlock features of the brewer. For example, a given brewer may be programmed to support a given feature with a bean container that has one key value, but not another. For example, in some cases the brewer may be sold at a lower price, but it is programmed to only work with bean containers that sell at a higher price. In some cases, the brewer may be programmed to only work with bean containers that have a given key value. In some cases, the brewer may be programmed with brew characteristics tailored to different members of a household, and those brew characteristics may be tied to bean containers with specific keys that are associated with those family members. In some cases, a roaster may identify desirable brewing characteristics for a specific bean and roast (temperature, soak time, ground coffee to water ratio, etc.), and those brewing characteristics may be programmed into the tag for that container.

In some cases, the information described above for a RFID or NFC tag may be stored in an optical code, such as a QR code.

In some cases, an RFID or NFC tag may be used on a re-usable container. In some cases, an RFID or NFC tag may be present on the re-usable grinder assembly 300 instead of the single use container. In these cases, the computer can track the usage of that specific grinder or container and know how many beans are left in it. The computer may monitor the electrical current of the grinder motor so that it can sense when a bean container becomes empty due to a current drop. This current drop and the act of the user removing the grinder/container assembly 110 from the appliance 100, tell the computer that this specific grinder or re-usable container is being attached to a new bean container or being refilled. The computer can then reset the counter, and track the usage starting from a known point of a full container.

In a system with or without RFID, this current drop information can also be utilized by the computer in the event that the bean container runs out of beans during a grinding process. From the current monitoring, the computer knows how much has been ground so far and how much more grinding is needed to achieve the selected size and strength. The computer can give the user the option to add more beans and grind then brew the original size, or to brew a smaller cup with the available beans using the same desired coffee to water ratio.

### IV.E. Alternative Approaches for Single-Use Bean Containers

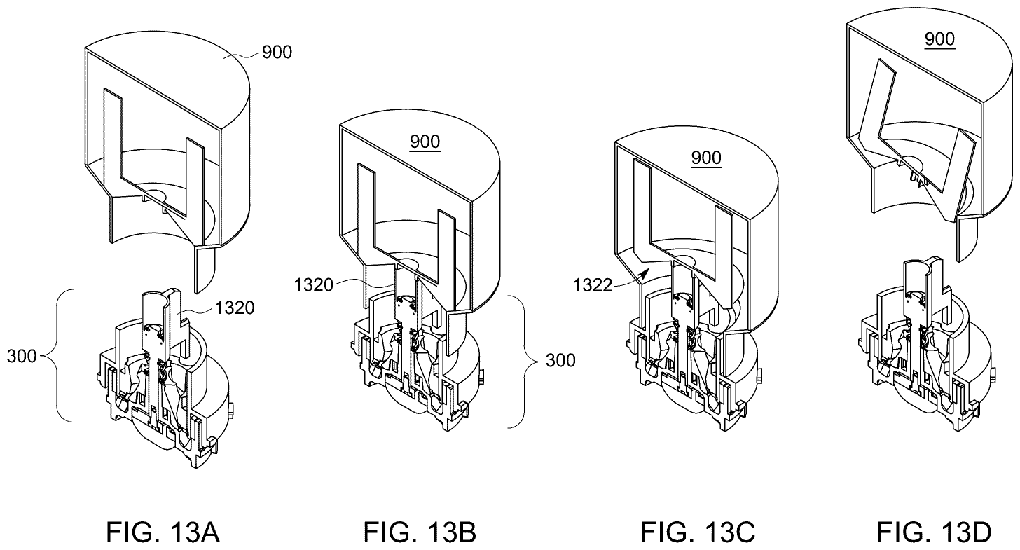

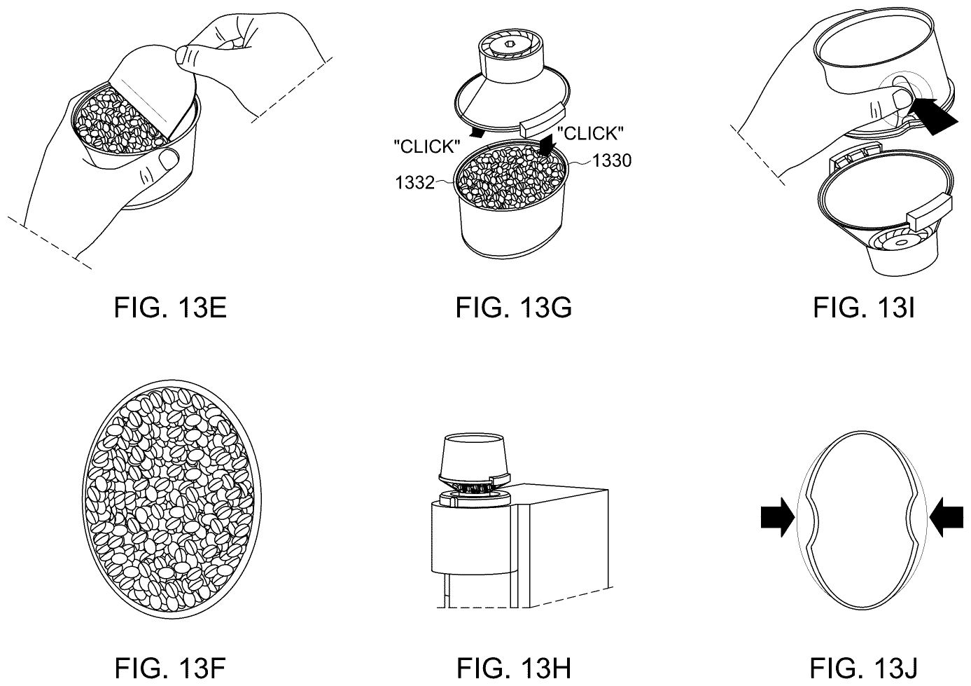

Referring to FIGS. 13A-13D, in some cases, container 900 may be designed as a single-use disposable. In some cases, the opening to the beans may be sold with a seal, and the seal is opened when the container is connected to grinder 300, to keep the beans fresh during the connection and opening process. Single-use bean containers may be designed around several concepts. In each case, it may be desirable that a single-use container be recyclable, which generally means that it should be formed of a single material.

Referring to FIG. 13A to FIG. 13D, in one design, bean container 900 is designed with a peel-away outer seal/lid. When the outer seal/lid is peeled away, an inner seal or wall 1322 continues to protect the beans. The grinder support structure has post 1320. When grinder assembly 300 is affixed to bean container 900, for example by twisting, post 1320 opens the container's inner seal 1322, which allows the beans to flow into the grinder. The conical shape of seal 1322 allows beans to flow around it and into grinder 300. Once joined, the grinder/container assembly may be used in grind-and-brew appliance 100. After uses that empty bean container 900, the grinder 300 may be released from container 900, for example, by unthreading.

Referring to FIG. 13D, the inner seal 1310 may be designed to prevent reuse of bean container 900. When bean container 900 is empty, the grinder and bean container may be detached from each other. Inner seal 1322 may be dimensioned to not fit through the opening on bean container 900 and be held captive, but to sufficiently obstruct the opening to prevent refilling of container 900.

Referring to FIGS. 13E to 13J, bean container 900 may be formed as a thin aluminum container, for example, using deep-draw, stamped, or other aluminum manufacturing process. In some cases, another material may be used. Container 900 may sold sealed with a tear-off seal/lid, also typically aluminum or aluminized paper. A plastic snap-on tear-off connector ring 1330 may function as the connector to the grinder. The grinder may attach by clicking 1332 into the snap-on tear-off connector ring 1330. The grinder may be used until bean container 900 is empty. To separate the grinder from container 900 (and to be transferred to the next container), a pull-tab may initiate tearing of the snap-on tear-off connector ring, or release may be effectuated (FIGS. 131 and 13J) by squeezing container 900 to deform it so it no longer seals to the connector. As part of human-factors engineering, the tear-off tab may be designed to discourage tear-off use too early, before the beans are exhausted. In some cases, the tab may be recessed so that before bean container 900 is affixed to the grinder, the tab cannot be grasped. Only when the grinder is snapped into place will the tab for the tear strip be forced outwards, exposed and graspable. The grinder may be entirely separated for reuse on the next container of beans. The grinder may attach to the container via a twist ring, The container may be formed of thin aluminum. In the process of twisting, the twist ring collar may dent or deform the thin aluminum container, freeing it from snap features and allowing it to be removed, but also preventing it from being reused (or alternatively deterring the user from wanting to reuse it). In some cases, deformation of container 900 may occur during the initial mating of container 900 to the grinder, preventing re-use once container 900 is later removed from the grinder. Alternatively, container 900 and grinder may be separated by squeezing container 900 to release it from the snaps. By squeezing the aluminum container, the user permanently deforms it, preventing reuse. To ease this squeeze, container 900 may be oval shaped instead of circular, and the receiving features of the grinder may likewise be oval shaped to track. The oval shape ensures that the user will intuitively squeeze container 900 in the orientation that will release it from the snaps. The oval shape may also reduce the amount of force that must be exerted to release the snap connector. Container 900 itself is now separated, and because it is single-material aluminum it is easily recycled. The connector ring is also a single material, and is likewise now recyclable. The consumer's ability to refill container 900 with beans may be limited because bean container 900 is no longer attached to the snap-on tear-off connector ring, or is deformed. It is not possible to remove bean container 900 from the grinder without tearing off the snap-on tear-off connector ring. Without the snap-on ring, reattachment or reinstallation of container 900 onto the grinder or grind-and-brew appliance 100 may be impractical.

When container 900 is empty, the user twists the twist ring collar 1010 or similar to release bean container 900.

### IV.F. Single Serving Reusable Container

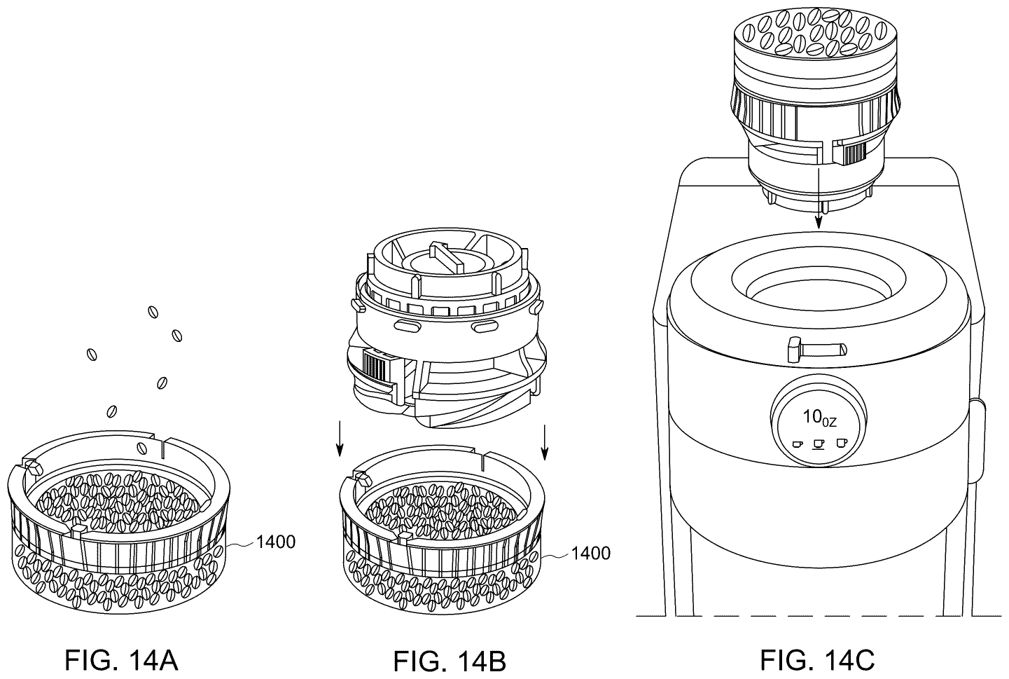

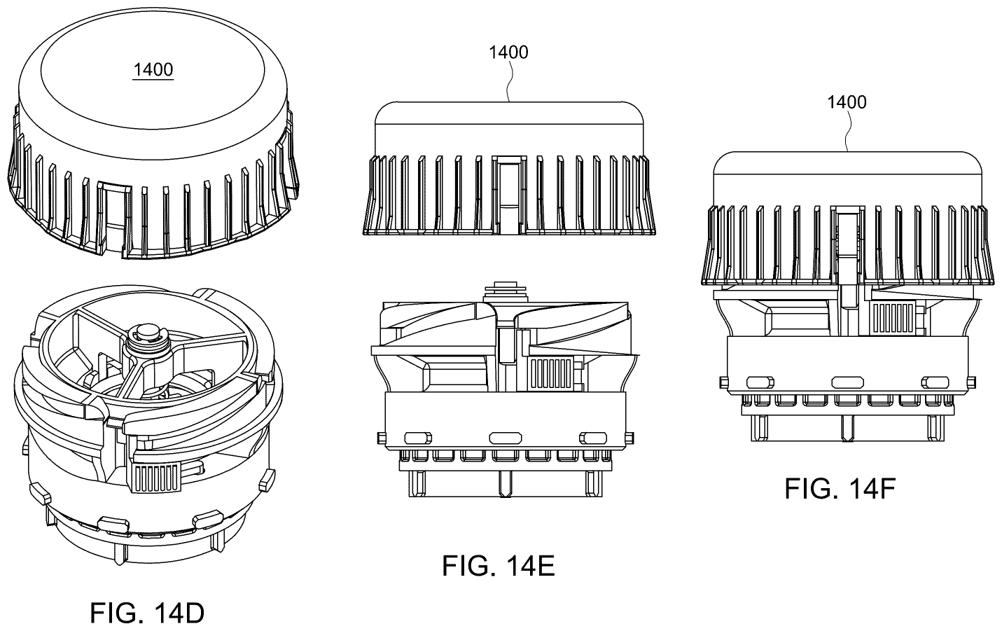

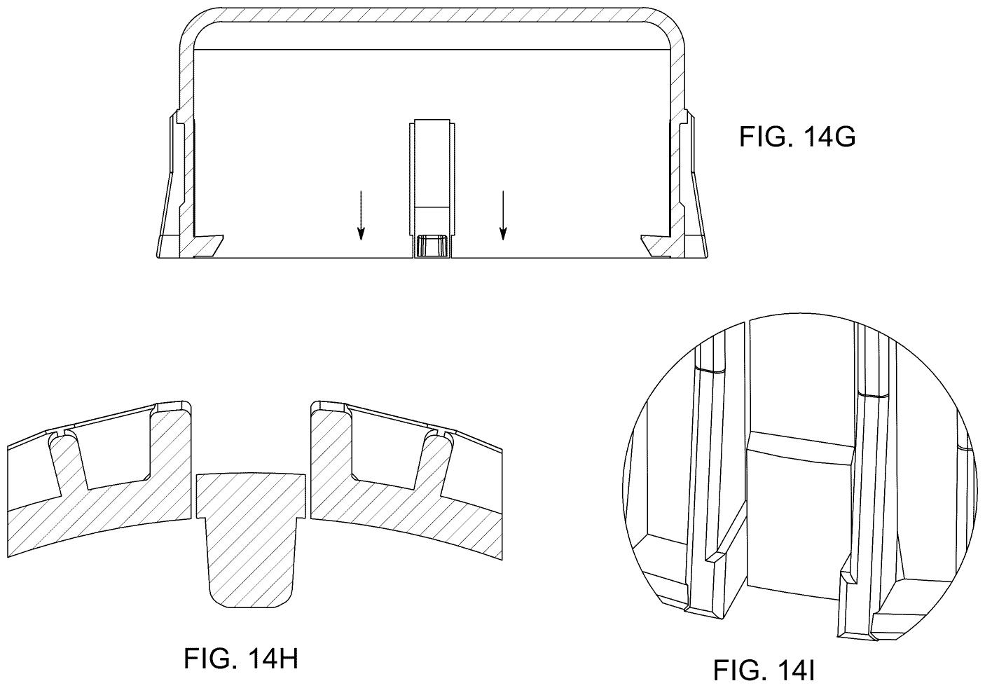

Referring to FIGS. 14A to 14I, a single-serving reusable bean container 1400 may hold one serving's worth of beans, to allow a user to make sample single servings of coffee with any beans the customer may choose. Single-serving bean container 1400 may have a thread-like feature similar to that of container-side connector collar 1010 discussed in FIGS. 10A to 11K, designed to engage with and lock on to the male threaded grinder-side connector 1020. Referring to FIGS. 14D to 14I, and contrasting to FIGS. 11D to 11F, single-serving reusable bean container 1400 may have components that engage a safety interlock switch via actuator 1050 to allow the grinder to run (similarly to FIG. 10L), but without the single-use self-destruct capabilities. Container 1400 may have a capacity corresponding to a single cup serving, generally from 0.5 oz to 1.5 oz by weight of whole beans, such as 0.5 oz, 0.6 oz, 0.7 oz, 0.8 oz, 0.9 oz, 1.0 oz, 1.2 oz, 1.4 oz, or 1.5 oz. of whole beans. In some cases, a series of sizes may be sold as a kit, and the user can pick one corresponding to the cup size and strength of coffee the user prefers. In some cases, the same concept may be used with a container designed to hold a larger amount of beans, enough for multiple servings of coffee. In some cases, this may be accomplished by incorporating the grinder and container into one part. In some cases, this single serving reusable container may be configured as a simple cover over the grinder that similarly actuates a safety switch via actuator 1050. In this case, the grinder may be configured to hold a sufficient amount of beans for a single serving, allowing the user to pour the beans directly into the grinder, then place the cover on top.

Referring to FIG. 14A, a consumer may place one serving worth of beans in container 900. Referring to FIG. 14B, the grinder assembly may be lowered onto single-serving container, and pushed to interlock. Referring to FIG. 14C, the single-service container and grinder may be lowered into grind-and-brew appliance 100, and used to prepare a singe serving of coffee.

### V. Other Embodiments

Because the grinder and container may be swapped out, grinder appliance 100 may be used to grind other foodstuffs. For example, grinder appliance 100 may be used to grind fresh nut butter, such as peanut butter, almond butter, or cashew butter. In some cases, grinder appliance 100 may be specialized to grinding spices. For grinding nut butter, the foodstuffs container may contain whole nuts or it may contain partially ground nuts to aid in the grinding process. In some cases, coffee, nuts, and spice grinders and containers may be swapped out and in in the same grinder appliance 100. These grinders may function on the same grinder appliance 100, or there may be a separate appliance 100 with a similar grinder drive train configuration. In some cases, for example when grinding nuts, the foodstuffs container may be designed to hold a single serving size of foodstuffs, this would allow for cleaning of the grinder between each use, which may be necessary for nut butter or grinding of other foodstuffs. This may be the case for a container with whole coffee beans as well.

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially.

The invention claimed is:

1. A method comprising the steps of:
brewing a first cup of coffee in a coffee brewer machine designed for consumer use, the machine comprising:
a countertop appliance with a motor designed to drive a grinder burr, and an area to receive ground foodstuff;
a first grinder/container assembly having a grinder burr and a container designed to hold whole coffee beans to be ground;
a coupling between the countertop appliance and grinder/container assembly coupling being designed to transmit power from the motor to the grinder burr, and being designed to permit separation of the grinder/container assembly from the countertop appliance and replacement in the countertop appliance of another grinder/container assembly, without use of tools;
after the first cup of coffee is brewed, removing the first grinder/container assembly from the countertop appliance, without the use of tools;
coupling a second grinder/container assembly into the countertop appliance, without the use of tools.

2. The method of claim 1, further comprising the steps of:
decoupling a container for unground foodstuffs from the grinder/container assembly at a connector for connection to a grinder housing, the grinder housing being designed to mount the grinder burr in a countertop appliance;
connecting a new container of unground foodstuffs to the grinder housing to form a new container/grinder assembly.

3. The method of claim 1, further comprising the steps of:
grinding the coffee for the first cup via the grinder burr, a filter basket below the grinder burr designed to collect grounds from the grinder burr and designed to direct water to percolate through the grounds, a water heating and distribution system, and a computer control;
the grinder burr arranged for rotation on a vertical axis, and to distribute grounds from its bottom in a conical distribution;
the filter basket having a raised center and a surrounding annular volume arranged at a diameter to collect the grounds as they fall from the grinder burr, and having screens of porosity to percolate water flow through after the screens while preventing throughflow of grounds, the raised center and screens designed to encourage water flow through the grounds for a desired level of extraction.

4. The method of claim 1, further comprising the steps of:
decoupling a container designed to hold a quantity of foodstuff up to about 3 liters from the grinder/container assembly at a connector for connection to a grinder housing, the grinder housing being designed to mount the grinder burr in a countertop appliance, the container and/or coupling between the container and grinder burr being designed to deter refilling of the container;
connecting a new container of unground foodstuffs to the grinder housing to form a new container/grinder assembly.

5. The method of claim 1, wherein:
brewing the first cup of coffee into a filter basket of the countertop appliance, the filter basket defining a circular brewing vessel, the filter basket being circular, the bottom of the filter basket having a raised center sloping away from the center and designed to promote outward flow of water, the basket bottom tending toward flat toward its radially-outer extent in order to provide adequate volume for grounds, and openings at or near the outer periphery of the filter basket, a ratio of the diameter to depth of the filter basket being at least about 2.5 to 1;
the filter basket being of materials suitable for use with foodstuffs and exposure to hot water;
the filter basket having features to engage with mating features of the countertop appliance.

6. An apparatus, comprising:
a grinder burr;
a grinder housing being designed to mount the grinder burr in a consumer countertop appliance and to:
receive drive power from a motor of the countertop appliance for drive of the grinder burr;
retain a container for unground foodstuffs as a container/grinder assembly, with the container positioned for gravity feed into the grinder burr, and for handling of the container and grinder burr as an assembly;
retain the grinder burr in a fashion and location to direct foodstuffs to flow from the container into the grinder burr, and to direct ground foodstuffs to be delivered into a receptacle;
a grinder-to-appliance coupling being designed to permit a user to readily mount the container/grinder assembly in and remove from the countertop appliance assembly, and replacement in the appliance with another container/grinder assembly.

7. The apparatus of claim 6:
the grinder-to-appliance coupling and a grinder-to-container coupling being jointly designed to permit ready separation and replacement of the grinder/container assembly from and into the appliance while holding the container in the container/grinder assembly without separating.

8. The apparatus of claim 7 wherein:
the grinder-to-appliance coupling is designed to permit a user to readily mount the container/grinder assembly in and remove from the countertop appliance assembly without the use of tools.

9. The apparatus of claim 7 wherein:
the grinder-to-container coupling is designed to allow the user to separate the container from the grinder housing without the use of tools.

10. The apparatus of claim 6, wherein:
a grinder-to-container coupling is designed to impair reuse of the container after separation.

11. The apparatus of claim 6, wherein:
the path from grinder to ground foodstuff receiving area designed for nearly vertical drop and reduced sticking of ground foodstuff.

12. The apparatus of claim 6, wherein:
wherein the container and grinder burr are designed for unground whole bean coffee, and to grind the unground beans to grounds for brewing;
the appliance further comprising a water delivery system and water heater for delivery of water for brewing of coffee.

13. The apparatus of claim 6, further comprising:
a container for unground foodstuffs, the container having a connector for connection to the grinder housing.

14. The apparatus of claim 6, further comprising:
and further comprising a filter basket below the grinder burr designed to collect grounds from the grinder burr and to direct water to percolate through the grounds, a water heating and distribution system, and a computer control;
the grinder burr being arranged for rotation about a vertical axis, and to distribute grounds from its bottom in a conical distribution;
the filter basket having a raised center and a surrounding annular volume arranged at a diameter to collect the grounds as they fall from the grinder burr, and having screens of porosity to direct water to flow through after the screens while preventing throughflow of grounds, the raised center and screens designed to encourage water flow through the grounds for a desired level of a desired level of extraction.

15. The apparatus of claim 6, further comprising:
a container for unground foodstuffs, the container having a connector for connection to the grinder housing, the container designed to hold a quantity of foodstuff up to about 3 liters;
the container and/or coupling of the container to the grinder burr assembly being designed to deter refilling of the container.

16. The apparatus of claim 6, further comprising:
a circular filter basket, the bottom of the filter basket having a raised center sloping away from the center and designed to promote outward flow of water, the basket bottom tending toward flat toward its radially-outer extent in order to provide volume for grounds, the filter basket having screen openings at or near the outer periphery of the filter basket, a ratio of the diameter to depth of the filter basket being at least about 2.5 to 1;
the filter basket being of materials suitable for use with foodstuffs and exposure to hot water;
the filter basket having features to engage with mating features of a grind-and-brew machine for hot beverages.

17. The apparatus of claim 6, further comprising:
a filter basket designed to hold ground foodstuff ground by the grinder burr and to direct flow of hot water in a manner designed to brew hot beverages;
a steam shield designed to lie in an open position during operation of the grinder burr to direct passage of grounds from the grinder burr to the filter basket, and to lie in a closed position after grinding and during brewing to protect the grinder burr from escape of steam during the brewing of the hot beverage;
the steam shield having on its lower surface one or more distribution openings designed to distribute water to the ground foodstuff in the filter basket for brewing.

18. The apparatus of claim 6, further comprising:
a water pump designed to distribute hot water to grounds in a brewing chamber of the apparatus; and
a controller designed to improve wetting of or extraction from the ground food stuff during brewing by pulsing the water pump during brewing.

19. The apparatus of claim 6, further comprising:
a controller that controls the rotation of the motor and grinder burr, the controller programmed to drive the motor in a grinding direction to drive the grinder burr to grind foodstuff during a grind cycle, and to conclude the grind cycle with a short reverse time to drive the grinder burr in a reverse direction to clear the grinder burr and other rotating components of residual ground foodstuff.

20. An apparatus, comprising:
a container for unground foodstuffs, the container having a connector for connection to a grinder housing, the grinder housing being designed to mount a grinder burr in a consumer countertop appliance and to:
receive drive power from a motor of the countertop appliance for drive of the grinder burr;
retain the container for unground foodstuffs as a container/grinder assembly, with the container positioned for gravity feed into the grinder burr, and for handling of the container and grinder burr as an assembly;
retain the grinder burr in a fashion and location designed to direct foodstuffs to flow from the container into the grinder burr, and to direct ground foodstuffs to be delivered into a receptacle;
a grinder-to-appliance coupling of the grinder housing being designed to permit a user to readily mount the container/grinder assembly in and remove from the countertop appliance assembly, and replacement in the appliance with another container/grinder assembly.

21. The apparatus of claim 20:
the grinder-to-appliance coupling and a grinder-to-container coupling being jointly designed to permit ready separation and replacement of the grinder/container assembly from and into the appliance while holding the container in the container/grinder assembly without separating.

22. The apparatus of claim 21 wherein:
the grinder-to-appliance coupling is designed to permit a user to readily mount the container/grinder assembly in and remove from the countertop appliance assembly without the use of tools.

23. The apparatus of claim 21 wherein:
the grinder-to-container coupling is designed to allow the user to separate the container from the grinder housing without the use of tools.

24. The apparatus of claim 20, wherein:
a grinder-to-container coupling is designed to impair reuse of the container after separation.

25. The apparatus of claim 20, wherein:
the path from grinder to ground foodstuff receiving area designed for nearly vertical drop and reduced sticking.

26. The apparatus of claim 20, wherein:
wherein the container and grinder burr are designed for unground whole bean coffee, and to grind the unground beans to grounds for brewing;
the appliance further comprising a water delivery system and water heater for delivery of water for brewing of coffee.

27. The apparatus of claim 20, further comprising:
a grinder burr;
a grinder housing being designed to mount the grinder burr in a countertop appliance.

28. The apparatus of claim 20, further comprising:
and further comprising a filter basket below the grinder burr designed to collect grounds from the grinder burr and to direct water to percolate through the grounds, a water heating and distribution system, and a computer control;
the grinder burr being arranged for rotation about a vertical axis, and to distribute grounds from its bottom in a conical distribution;
the filter basket having a raised center and a surrounding annular volume arranged at a diameter to collect the grounds as they fall from the grinder burr, and having screens of porosity to direct water to flow through after the screens while preventing throughflow of grounds, the raised center and screens designed to encourage water flow through the grounds for a desired level of extraction.

29. The apparatus of claim 20, further comprising:
a container for unground foodstuffs, the container having a connector for connection to the grinder housing, the container designed to hold a quantity of foodstuff up to about 3 liters;
the container and/or coupling of the container to the grinder burr assembly being designed to deter refilling of the container.

30. The apparatus of claim 20, further comprising:
a circular filter basket, the bottom of the filter basket having a raised center sloping away from the center and designed to promote outward flow of water, the basket bottom tending toward flat toward its radially-outer extent in order to provide volume for grounds, the filter basket having screen openings at or near the outer periphery of the filter basket, a ratio of the diameter to depth of the filter basket being at least about 2.5 to 1;
the filter basket being of materials suitable for use with foodstuffs and exposure to hot water;
the filter basket having features to engage with mating features of a grind-and-brew machine for hot beverages.

31. The apparatus of claim 20, further comprising:
a filter basket designed to hold ground foodstuff ground by the grinder burr and to direct passage of hot water in a manner designed to brew hot beverages;
a steam shield designed to lie in an open position during operation of the grinder burr to direct passage of grounds from the grinder burr to the filter basket, and to lie in a closed position after grinding and during brewing to protect the grinder burr from escape of steam during the brewing of the hot beverage;
the steam shield having on its lower surface one or more distribution openings designed to distribute water to the ground foodstuff in the filter basket for brewing.

32. The apparatus of claim 20, further comprising:
a water pump designed to distribute hot water to grounds in a brewing chamber of the apparatus; and
a controller designed to improve wetting of or extraction from the ground food stuff during brewing by pulsing the water pump during brewing.

33. The apparatus of claim 20, further comprising:
a controller that controls the rotation of the motor and grinder burr, the controller programmed to drive the motor in a grinding direction to drive the grinder burr to grind foodstuff during a grind cycle, and to conclude the grind cycle with a short reverse time to drive the grinder burr in a reverse direction to clear the grinder burr and other rotating components of residual ground foodstuff.

34. An apparatus, comprising:
a grinder burr arranged for rotation on a vertical axis, and to distribute grounds from its bottom in a conical distribution to land in an annulus;
a filter basket below the grinder burr designed to collect grounds from the grinder burr and to direct water to percolate through the grounds, a water heating and distribution system, and a computer control;
the filter basket being formed of materials suitable for use with foodstuffs and exposure to hot water, the filter basket having features to engage with mating features of a grind-and-brew machine for hot beverages for consumer use, the filter basket having a raised center and a surrounding annular volume arranged at a diameter to collect the grounds as they fall from the grinder burr, and having screens of porosity to direct hot beverage to flow through the screens while preventing throughflow of grounds, the raised center and screens designed to encourage water flow through the grounds for a desired level of extraction.

35. The apparatus of claim 34, further comprising:
a motor, a rotational axis of the motor being different that the vertical axis of rotation of the grinder burr;
gears and/or belts designed to transfer rotational impulse from the motor to the rotary grinder burr.

36. The apparatus of claim 34, further comprising:
support ribs designed to positionally retain the grinder burr relative to the filter basket, the support ribs being angled to reduce sticking of falling grounds.

37. The apparatus of claim 34, further comprising:
vertical stationary walls of a fall path from the grinder burr, the vertical stationary walls being designed to shield rotating walls from the grounds to reduce sticking/.

38. The apparatus of claim 34, further comprising:
a container for unground foodstuffs, the container having a connector for connection to a grinder housing, the grinder housing being designed to mount a grinder burr in a countertop appliance and to:
receive drive power from a motor of the countertop appliance for drive of the grinder burr;
retain the container for unground foodstuffs as a container/grinder assembly, with the container positioned for gravity feed into the grinder burr, and for handling of the container and grinder burr as an assembly;
retain the grinder burr in a fashion and location to direct foodstuffs to flow from the container into the grinder burr, and to direct ground foodstuffs to be delivered into a receptacle;
a grinder-to-appliance coupling of the grinder housing being designed to permit a user to readily mount the container/grinder assembly in and remove from the countertop appliance assembly, and replacement in the appliance with another container/grinder assembly.

39. The apparatus of claim 34, further comprising:
a container for unground foodstuffs, the container having a connector for connection to a grinder housing, the container designed to hold a quantity of foodstuff up to about 3 liters, the grinder housing being designed to mount a grinder burr in a countertop appliance and to:
receive drive power from a motor of the countertop appliance for drive of the grinder burr;
retain the container for unground foodstuffs as a container/grinder assembly, with the container positioned for gravity feed into the grinder burr, and for handling of the container and grinder burr as an assembly;
retain the grinder burr in a fashion and location to direct foodstuffs to flow from the container into the grinder burr;
a grinder-to-appliance coupling of the grinder housing being designed to permit a user to readily mount the container/grinder assembly in and remove from the countertop appliance assembly;
the container and/or coupling of the container to the grinder burr assembly being designed to deter refilling of the container.

40. The apparatus of claim 34:
wherein the filter basket has a bottom having a raised center sloping away from the center and designed to promote outward flow of water, the basket bottom tending toward flat toward its radially-outer extent in order to provide volume for grounds, the filter basket having screen openings at or near the outer periphery of the filter basket, a ratio of the diameter to depth of the filter basket being at least about 2.5 to 1.

41. The apparatus of claim 34, further comprising:
a filter basket designed to hold ground foodstuff ground by the grinder burr and to direct flow of water in a manner designed to brew hot beverages,
a steam shield designed to lie in an open position during operation of the grinder burr to direct passage of grounds from the grinder burr to the filter basket, and to lie in a closed position after grinding and during brewing to protect the grinder burr from escape of steam from the brewing process;
the steam shield having on its lower surface one or more distribution openings designed to distribute water to the ground foodstuff in the filter basket for brewing.

42. The apparatus of claim 34, further comprising:
a water pump designed to distribute hot water to ground coffee in a brewing chamber of the coffee brewer appliance; and
a controller designed to improve wetting of or extraction from the ground food stuff during brewing by pulsing the water pump during brewing.

43. The apparatus of claim 34, further comprising:
a brew basket surrounding the filter basket, designed to catch brewed coffee exiting the filter basket, the brew basket having a drip valve actuated by a motor of the appliance, the drip valve designed to allow flow of coffee or prevent flow of coffee as determined by a controller of the appliance.

44. The apparatus of claim 34, further comprising:
a countertop appliance with a motor designed to drive a grinder burr, and an area to receive ground foodstuff;
a controller that controls the rotation of the motor and grinder burr, the controller programmed to drive the motor in a grinding direction to drive the grinder burr to grind foodstuff during a grind cycle, and to conclude the grind cycle with a short time to drive the grinder burr in a reverse direction to clear the grinder burr and other rotating components of residual ground foodstuff.

45. An apparatus, comprising:
a container for unground foodstuffs, the container having a connector for connection to a grinder housing, the container designed to hold a quantity of foodstuff up to about 3 liters, the grinder housing being designed to mount a grinder burr in a consumer countertop appliance and to:
receive drive power from a motor of the countertop appliance for drive of the grinder burr;
retain the container for unground foodstuffs as a container/grinder assembly, with the container positioned for gravity feed into the grinder burr, and for handling of the container and grinder burr as an assembly;
retain the grinder burr in a fashion and location to direct foodstuffs to flow from the container into the grinder burr;
a grinder-to-appliance coupling of the grinder housing being designed to permit a user to readily mount the container/grinder assembly in and remove from the countertop appliance assembly;
the container and/or container-to-grinder coupling being designed to deter refilling of the container.

46. The apparatus of claim 45, wherein:
the container and/or container-to-grinder coupling being designed to permit decoupling of the grinder burr from the container and to deter refilling of the container, and re-coupling of a new container, without use of tools.

47. The apparatus of claim 46, wherein:
the container-to-grinder coupling and/or container have features that, during disconnection of the grinder from the container, are designed to deform features of the container and/or the container side of the container-to-grinder coupling so that the container-to-grinder coupling cannot be reused.

48. The apparatus of claim 47, wherein:
the container-to-grinder coupling has features that actuate a safety switch of the appliance when the grinder and container are connected,
the deformation of the container and/or the container side is designed to prevent actuation of the safety switch after the deformation.

49. The apparatus of claim 47, wherein:
components of the container-to-grinder coupling are designed to snap to hold features of the container-to-grinder coupling in an inoperative position designed to prevent reuse of the container-to-grinder coupling.

50. The apparatus of claim 49, wherein:
the container-to-grinder coupling are designed with an inclined ramp and features that ride that ramp during rotation of components of the coupling.

51. The apparatus of claim 47, wherein:
the container-to-grinder coupling has features that, during disconnection of the grinder from the container, are designed to yield so that the first coupling cannot be reused.

52. The apparatus of claim 47, wherein:
the container-to-grinder coupling has features that require the user to deform the features in order to release the container from the grinder.

53. The apparatus of claim 45, wherein:
a rotary grinder burr mounted on a vertical axis, a filter basket below the grinder burr designed to collect grounds from the grinder burr and to direct water to percolate through the grounds, a water heating and distribution system, and a computer control;
the grinder burr arranged for rotation on a vertical axis, and to distribute grounds from its bottom in a conical distribution;
the filter basket being formed of materials suitable for use with foodstuffs and exposure to hot water, the filter basket having features to engage with mating features of a grind-and-brew machine for hot beverages, the filter basket having a raised center and a surrounding annular volume arranged at a diameter to collect the grounds as they fall from the grinder burr, and having screens of porosity to direct water to flow through after the screens while preventing throughflow of grounds, the raised center and screens designed to encourage water flow through the grounds for a desired level of extraction.

54. An apparatus, comprising:
a filter basket being formed of materials suitable for use with foodstuffs and exposure to hot water, the filter basket having features to engage with mating features of a consumer grind-and-brew machine for hot beverages, the filter basket designed to hold ground foodstuff ground by a grinder burr and to direct flow of water in a manner designed to brew hot beverages;
the bottom of the filter basket having a raised center sloping away from the center and designed to promote outward flow of water, the filter basket having screen openings at or near the outer periphery of the filter basket, a ratio of the diameter to depth of the filter basket being at least about 2.5 to 1.

55. The apparatus of claim 54, wherein
the bottom of the filter basket is water impermeable, and the screen openings are in vertical sides for the filter basket.

56. The apparatus of claim 54, wherein:
the bottom of the filter basket is shaped as a surface of rotation around a central axis of the filter basket of a curve having a higher pitch toward the center and a flattening toward the periphery.

57. The apparatus of claim 54, wherein:
the ratio of the diameter to depth of the filter basket is at least about three to one.

58. The apparatus of claim 54, wherein:
a grinder burr;
a grinder housing being designed to mount the grinder burr in a countertop appliance and to:
receive drive power from a motor of the countertop appliance for drive of the grinder burr;
retain a container for unground foodstuffs as a container/grinder assembly, with the container positioned for gravity feed into the grinder burr, and for handling of the container and grinder burr as an assembly;
retain the grinder burr in a fashion and location to direct foodstuffs to flow from the container into the grinder burr, and to direct ground foodstuffs to be delivered into a receptacle;
a grinder-to-appliance coupling being designed to permit a user to readily mount the container/grinder assembly in and remove from the countertop appliance assembly, and replacement in the appliance with another container/grinder assembly.

59. The apparatus of claim 54, wherein:
a rotary grinder burr mounted on a vertical axis, a water heating and distribution system, and a computer control;
the grinder burr arranged for rotation on a vertical axis, and to distribute grounds from its bottom in a conical distribution to land in an annulus of the filter basket;
the filter basket having a raised center and a surrounding annular volume arranged at a diameter to collect the grounds as they fall from the grinder burr, and having screens of porosity to direct water to flow through after the screens while preventing throughflow of grounds, the raised center and screens designed to encourage water flow through the grounds for a desired level of extraction.

60. The apparatus of claim 54, further comprising:
a container for unground foodstuffs, the container having a connector for connection to a grinder housing, the container designed to hold a quantity of foodstuff up to about 3 liters, the grinder housing being designed to mount a grinder burr in a countertop appliance and to:
receive drive power from a motor of the countertop appliance for drive of the grinder burr;
retain the container for unground foodstuffs as a container/grinder assembly, with the container positioned for gravity feed into the grinder burr, and for handling of the container and grinder burr as an assembly;
retain the grinder burr in a fashion and location to direct foodstuffs to flow from the container into the grinder burr and to deliver grounds into the filter basket;
a grinder-to-appliance coupling of the grinder housing being designed to permit a user to readily mount the container/grinder assembly in and remove from the countertop appliance assembly;
the container and/or container-to-grinder coupling being designed to deter refilling of the container.

61. The apparatus of claim 54, wherein:
a steam shield designed to lie in an open position during operation of the grinder burr to direct passage of grounds from the grinder burr to the filter basket, and to lie in a closed position after grinding and during brewing to protect the grinder burr from escape of steam from the brewing process;
the steam shield having on its lower surface one or more distribution openings designed to distribute water to the ground foodstuff in the filter basket for brewing.

62. The apparatus of claim 54, further comprising:
a water pump designed to distribute hot water to ground coffee in a brewing chamber of the coffee brewer appliance; and
a controller designed to improve wetting of or extraction from the ground food stuff during brewing by pulsing the water pump during brewing.

63. The apparatus of claim 54, wherein:
a brew basket surrounding the filter basket, designed to catch brewed coffee exiting the filter basket, the brew basket having a drip valve actuated by a motor of the appliance, the drip valve designed to allow flow of coffee or prevent flow of coffee as determined by a controller of the appliance.

64. The apparatus of claim 54, further comprising:
an countertop appliance with a motor designed to drive the grinder burr, and an area to receive ground foodstuff;
a controller that controls the rotation of the motor and grinder burr, the controller programmed to drive the motor in a grinding direction to drive the grinder burr to grind foodstuff during a grind cycle, and to conclude the grind cycle with a short time to drive the grinder burr in a reverse direction to clear the grinder burr and other rotating components of residual ground foodstuff.

65. An apparatus, comprising:
a grinder burr designed to grind foodstuff;
a filter basket designed to hold ground foodstuff ground by the grinder burr and to direct flow of water in a manner designed to brew hot beverages,
a steam shield designed to lie in an open position during operation of the grinder burr to direct passage of grounds from the grinder burr to the filter basket, and to lie in a closed position after grinding and during brewing to protect the grinder burr from escape of steam from the brewing process;
the steam shield having on its lower surface one or more distribution openings designed to distribute water to the ground foodstuff in the filter basket for brewing.

66. The apparatus of claim 65, wherein
the steam shield and water distribution leading to the distribution openings are formed as an integral part designed to move together on a common mechanism.

67. The apparatus of claim 66, wherein
the steam shield and water distribution leading to the distribution openings are formed as separately molded parts joined together into an integral part.

68. The apparatus of claim 65, further comprising:
a grinder housing being designed to mount the grinder burr in a countertop appliance and to:
receive drive power from a motor of the countertop appliance for drive of the grinder burr;
retain a container for unground foodstuffs as a container/grinder assembly, with the container positioned for gravity feed into the grinder burr, and for handling of the container and grinder burr as an assembly;
retain the grinder burr in a fashion and location to direct foodstuffs to flow from the container into the grinder burr, and to direct ground foodstuffs to be delivered into a receptacle;
a grinder-to-appliance coupling being designed to permit a user to readily mount the container/grinder assembly in and remove from the countertop appliance assembly, and replacement in the appliance with another container/grinder assembly.

69. The apparatus of claim 65:
wherein the grinder burr is arranged for rotation on a vertical axis, and to distribute grounds from its bottom in a conical distribution;
and further comprising:
a filter basket below the grinder burr designed to collect grounds from the grinder burr and to direct water to percolate through the grounds, a water heating and distribution system, and a computer control;
the filter basket being formed of materials suitable for use with foodstuffs and exposure to hot water, the filter basket having features to engage with mating features of a grind-and-brew machine for hot beverages, the filter basket having a raised center and a surrounding annular volume arranged at a diameter to collect the grounds as they fall from the grinder burr, and having screens of porosity to direct hot beverage to flow through the screens while preventing throughflow of grounds, the raised center and screens designed to encourage water flow through the grounds for a desired level of extraction.

70. The apparatus of claim 65, further comprising:
a container for unground foodstuffs, the container having a connector for connection to a grinder housing, the container designed to hold a quantity of foodstuff up to about 3 liters, the grinder housing being designed to mount the grinder burr in a countertop appliance and to:
receive drive power from a motor of the countertop appliance for drive of the grinder burr;
retain the container for unground foodstuffs as a container/grinder assembly, with the container positioned for gravity feed into the grinder burr, and for handling of the container and grinder burr as an assembly;
retain the grinder burr in a fashion and location to direct foodstuffs to flow from the container into the grinder burr;
a grinder-to-appliance coupling of the grinder housing being designed to permit a user to readily mount the container/grinder assembly in and remove from the countertop appliance assembly;
the container and/or container-to-grinder coupling being designed to deter refilling of the container.

71. The apparatus of claim 65, further comprising:
a filter basket being formed of materials suitable for use with foodstuffs and exposure to hot water, the filter basket having features to engage with mating features of a grind-and-brew machine for hot beverages, the filter basket designed to hold ground foodstuff ground by a grinder burr and to direct flow of water in a manner designed to brew hot beverages;
the bottom of the filter basket having a raised center sloping away from the center and designed to promote outward flow of water, the filter basket having screen openings at or near the outer periphery of the filter basket, a ratio of the diameter to depth of the filter basket being at least about 2.5 to 1.

72. Apparatus comprising:
a container for unground foodstuffs, the container having a connector for connection to a grinder housing, the container designed to hold a quantity of foodstuff up to about 3 liters;
a grinder burr arranged for rotation on a vertical axis;
a grinder housing being designed to:
retain the grinder burr in a consumer countertop appliance for rotation on a vertical axis;
receive drive power from a motor of the countertop appliance for drive of the grinder burr, the burr to distribute grounds from its bottom in a conical distribution to land in an annulus;
retain the container for unground foodstuffs as a container/grinder assembly, with the container positioned for gravity feed into the grinder burr, and for handling of the container and grinder burr as an assembly;
retain the grinder burr in a fashion and location designed to direct foodstuffs to flow from the container into the grinder burr, and to direct ground foodstuffs to be delivered into a receptacle;
a grinder-to-appliance coupling of the grinder housing being designed to permit a user to readily mount the container/grinder assembly in and remove from the countertop appliance assembly, and replacement in the appliance with another container/grinder assembly;
the container and/or container-to-grinder coupling being designed to deter refilling of the container;
the filter basket being formed of materials suitable for use with foodstuffs and exposure to hot water, the filter basket having features to engage with mating features of a grind-and-brew machine for hot beverages for consumer use, the bottom of the filter basket having a raised center sloping away from the center and designed to promote outward flow of water, and a surrounding annular volume arranged at a diameter to collect the grounds as they fall from the grinder burr, the filter basket having screen openings at or near the outer periphery of the filter basket, a ratio of the diameter to depth of the filter basket being at least about 2.5 to 1, and having screens of porosity to direct hot beverage to flow through the screens while preventing throughflow of grounds, the raised center and screens designed to encourage water flow through the grounds for a desired level of extraction;
a water heating and distribution system;
a computer control; and
a steam shield designed to lie in an open position during operation of the grinder burr to direct passage of grounds from the grinder burr to the filter basket, and to lie in a closed position after grinding and during brewing to protect the grinder burr from escape of steam from the brewing process;
the steam shield having on its lower surface one or more distribution openings designed to distribute water to the ground foodstuff in the filter basket for brewing.
